(19) United States
(12) Patent Application Publication
(10) Pub. No.: US 2026/0349361 A1
(43) Pub. Date: Nov. 5, 2026

(54) ELECTROPHOTOGRAPHIC PHOTORECEPTOR, PROCESS CARTRIDGE, AND IMAGE FORMING APPARATUS

(71) Applicant: KYOCERA DOCUMENT SOLUTIONS INC., OSAKA (JP)

(72) Inventors: RYOHEI YAMASAKI, OSAKA (JP); TETSUYA SENDA, OSAKA (JP)

(21) Appl. No.: 19/636,884

(22) Filed: Apr. 1, 2026

(30) Foreign Application Priority Data
Apr. 23, 2025 (JP) 2025-071880

(51) Int. Cl. G03G 5/06; G03G 5/05

(52) U.S. Cl. CPC G03G 5/0696; G03G 5/0546; G03G 5/0564; G03G 5/0589

(57) ABSTRACT

An electrophotographic photoreceptor includes a conductive base and a photosensitive layer. The photosensitive layer includes a charge generation layer and a charge transport layer. The charge transport layer includes a hole transport agent and a binder resin containing a first resin and a second resin. The first resin is a polycarbonate resin containing repeating units having siloxane structures, and a viscosity average molecular weight of the first resin is within a value range of 10,000 or more and 25,000 or less. The second resin is at least one type of resin selected from the group consisting of a polycarbonate resin and a polyarylate resin, which does not contain the repeating units having the siloxane structures. A content ratio of the first resin relative to the binder resin is 5 mass % or more and less than 35 mass %.

### CROSS-REFERENCE TO RELATED PATENT APPLICATION

This application claims the benefit of Japanese Priority Patent Application JP 2025-071880 filed on Apr. 23, 2025, the entire contents of the Japanese application are incorporated herein by reference.

### FIELD OF THE DISCLOSURE

The present disclosure relates to an electrophotographic photoreceptor, a process cartridge, and an image forming apparatus.

### BACKGROUND OF THE DISCLOSURE

An electrophotographic photoreceptor is used as an image carrier in an electrophotographic image forming apparatus (e.g., a printer or multifunction device). The electrophotographic photoreceptor includes a photosensitive layer. Examples of the electrophotographic photoreceptor include a single-layer electrophotographic photoreceptor and a laminated electrophotographic photoreceptor. The single-layer electrophotographic photoreceptor includes a single photosensitive layer that performs both charge generation and charge transport functions. The laminated electrophotographic photoreceptor separates these functions and includes a photosensitive layer formed by laminating a charge generation layer and a charge transport layer.

Here, a phenomenon where minute components such as paper dust adhere and become fixed to a surface of the photoreceptor is called filming. An occurrence of the filming results in formation of unclear images containing black dots and black streaks. Therefore, a photoreceptor with anti-filming properties is necessary.

### SUMMARY OF THE DISCLOSURE

According to an embodiment of the present disclosure, an electrophotographic photoreceptor includes a conductive base and a photosensitive layer.

The photosensitive layer includes a charge generation layer and a charge transport layer.

The charge transport layer includes a hole transport agent and a binder resin containing a first resin and a second resin.

The first resin is a polycarbonate resin containing repeating units having siloxane structures, and a viscosity average molecular weight of the first resin is within a value range of 10,000 or more and 25,000 or less.

The second resin is at least one type of resin selected from the group consisting of a polycarbonate resin and a polyarylate resin, which does not contain the repeating units having the siloxane structures.

A content ratio of the first resin relative to the binder resin is 5 mass % or more and less than 35 mass %.

### BRIEF DESCRIPTION OF THE DRAWINGS

FIG. 1 is a partial cross-sectional view of an electrophotographic photoreceptor according to a first embodiment of the present disclosure.

FIG. 2 is a partial cross-sectional view of the electrophotographic photoreceptor according to the first embodiment of the present disclosure.

FIG. 3 is a partial cross-sectional view of the electrophotographic photoreceptor according to the first embodiment of the present disclosure.

FIG. 4 is a diagram illustrating Young's equation.

FIG. 5 is a graph illustrating a method for calculating surface free energy.

FIG. 6 is a diagram showing an example of a configuration of an image forming apparatus according to a second embodiment of the present disclosure.

FIG. 7 is a diagram showing an example of a configuration of a developing device shown in FIG. 6.

### DETAILED DESCRIPTION OF THE EXEMPLARY EMBODIMENTS

Embodiments of the present disclosure will now be described in detail. However, the present disclosure is not limited to the embodiments described below and may be implemented with appropriate modifications within the scope of the object of the present disclosure. Furthermore, where descriptions overlap, the description may be omitted as appropriate, but the essence of the invention is not limited thereby. Hereinafter, the term “series” may be appended after a compound name to collectively refer to the compound and its derivatives. When the term “series” is appended after the compound name to denote a polymer name, it means that the repeating units of the polymer originate from the compound or its derivative. Furthermore, “a general formula” and “a chemical formula” are collectively referred to as “formula.” In the description of the formula, “independently” means that the same group may be represented or different groups may be represented. Unless otherwise specified, each component described herein may be used alone or in combination with two or more thereof.

Below, an alkyl group having 1 to 8 carbon atoms, an alkoxy group having 1 to 8 carbon atoms, an alkoxy group having 1 to 6 carbon atoms, a cycloalkane having 5 to 7 carbon atoms, and an aryl group having 6 to 14 carbon atoms have the meanings specified below.

The alkyl group having 1 to 8 carbon atoms is a straight-chain or branched-chain unsubstituted alkyl group having 1 to 8 carbon atoms. Examples of the alkyl groups having 1 to 8 carbon atoms include a methyl group, an ethyl group, a propyl group, an isopropyl group, an n-butyl group, an s-butyl group, a t-butyl group, a pentyl group, an isopentyl group, a neopentyl group, a hexyl group, a heptyl group, or an octyl group. Examples of the alkyl groups having 1 to 6 carbon atoms, the alkyl groups having 1 to 4 carbon atoms, and the alkyl groups having 1 to 3 carbon atoms are, respectively, those groups having the corresponding number of carbon atoms among the groups described as examples of the alkyl groups having 1 to 8 carbon atoms.

The alkoxy group having 1 to 8 carbon atoms is straight-chain or branched-chain unsubstituted alkoxy group having 1 to 8 carbon atoms. Examples of the alkoxy groups having 1 to 8 carbon atoms include a methoxy group, an ethoxy group, an n-propoxy group, an isopropoxy group, an n-butoxy group, an s-butoxy group, a t-butoxy group, a pentyloxy group, an isopentyloxy group, a neopentyloxy group, a hexyloxy group, a heptyloxy group, or an octyloxy group. Examples of the alkoxy group having 1 to 3 carbon atoms are those groups having the corresponding number of carbon atoms among the groups described as examples of the alkoxy group having 1 to 8 carbon atoms.

The cycloalkane having 5 to 7 carbon atoms is, for example, an unsubstituted cycloalkane having 5 to 7 carbon atoms. Examples of the cycloalkane having 5 to 7 carbon atoms include cyclopentane, cyclohexane, or cycloheptane.

The aryl group having 6 to 14 carbon atoms is, for example, an unsubstituted aromatic monocyclic hydrocarbon group having 6 to 14 carbon atoms, an unsubstituted aromatic fused bicyclic hydrocarbon group having 6 to 14 carbon atoms, or an unsubstituted aromatic fused tricyclic hydrocarbon group having 6 to 14 carbon atoms. Examples of the aryl groups having 6 to 14 carbon atoms include a phenyl group, a naphthyl group, an anthryl group, or a phenanthryl group.

The embodiments of the present disclosure will now be described with reference to the accompanying drawings.

### First Embodiment: Electrophotographic Photoreceptor

### Overview of the Disclosure

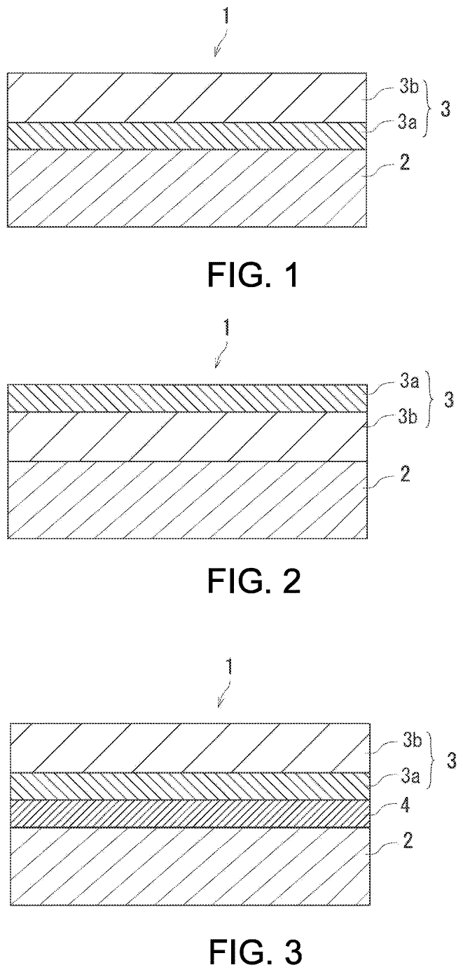

Hereinafter, an electrophotographic photoreceptor 1 (hereinafter also referred to simply as photoreceptor 1) according to an embodiment of the present disclosure will be described with reference to FIGS. 1 to 3. FIGS. 1 to 3 each shows a partial cross-sectional view of the photoreceptor 1.

As shown in FIG. 1, the photoreceptor 1 includes a conductive base 2 and a photosensitive layer 3. The photosensitive layer 3 includes a charge generation layer 3a and a charge transport layer 3b. That is, the photoreceptor 1 is a laminated photoreceptor having the charge generation layer 3a and the charge transport layer 3b as the photosensitive layer 3. The charge generation layer 3a is, for example, a single layer. The charge transport layer 3b is, for example, a single layer.

As shown in FIG. 1, the charge generation layer 3a may be provided on the conductive base 2, and the charge transport layer 3b may be provided on the charge generation layer 3a. Alternatively, as shown in FIG. 2, the charge transport layer 3b may be provided on the conductive base 2, and the charge generation layer 3a may be provided on the charge transport layer 3b.

As shown in FIG. 3, the photoreceptor 1 may further include an intermediate layer 4 (undercoat layer) in addition to the conductive base 2 and the photosensitive layer 3. The intermediate layer 4 is provided between the conductive base 2 and the photosensitive layer 3. As shown in FIGS. 1 and 2, in the photoreceptor 1, the photosensitive layer 3 may be provided directly on the conductive base 2. Alternatively, as shown in FIG. 3, in the photoreceptor 1, the photosensitive layer 3 may be provided on the conductive base 2 via the intermediate layer 4. When the photoreceptor 1 includes the intermediate layer 4, as shown in FIG. 3, the intermediate layer 4 may be provided on the conductive base 2, the charge generation layer 3a may be provided on the intermediate layer 4, and the charge transport layer 3b may be provided on the charge generation layer 3a. Alternatively, the intermediate layer 4 may be provided on the conductive base 2, the charge transport layer 3b may be provided on the intermediate layer 4, and the charge generation layer 3a may be provided on the charge transport layer 3b.

The photoreceptor 1 may further include a protective layer 5 (not shown) in addition to the conductive base 2 and the photosensitive layer 3. The protective layer 5 is provided on the photosensitive layer 3. As shown in FIGS. 1 to 3, the photosensitive layer 3 (e.g., the charge transport layer 3b or the charge generation layer 3a) may be provided as an outermost surface layer of the laminated photoreceptor 1. Alternatively, the protective layer 5 may be provided as the outermost surface layer of the laminated photoreceptor 1.

In the photoreceptor 1 according to one embodiment of the present disclosure, from the perspective of further improving a wear resistance and anti-filming properties described later, it is preferable that the charge transport layer 3b containing a first resin and a second resin be provided as the outermost surface layer of the photoreceptor 1, as shown in FIG. 1, and it is more preferable that the charge transport layer 3b is a single layer and is provided as the outermost surface layer of the laminated photoreceptor 1.

In the photoreceptor 1 according to this embodiment, the charge transport layer 3b contains a hole transport agent and a binder resin containing the first resin and the second resin. The first resin is a polycarbonate resin containing repeating units having siloxane structures, and a viscosity average molecular weight of the first resin is 10,000 or more and 25,000 or less. The second resin is at least one type of a resin selected from the group consisting of a polycarbonate resin and a polyarylate resin, which does not contain the repeating units having the siloxane structures. Furthermore, a content ratio of the first resin relative to the binder resin (hereinafter also referred to simply as the “first resin content ratio”) is 5% or more and less than 35%.

In the single-layer electrophotographic photoreceptor described in the above background, a disadvantage existed that incorporating a large amount of hydrophobic polycarbonate into the photosensitive layer reduced surface hardness and deteriorated wear resistance. Conversely, reducing the amount of hydrophobic polycarbonate incorporated tends to mitigate the deterioration in the wear resistance, but sufficient anti-filming properties cannot be obtained, creating a trade-off between the two. Therefore, achieving both excellent anti-filming properties and wear resistance is required. In response, the inventors of the present invention, through intensive research, discovered that for the polycarbonate resin (first resin) containing the repeating units having the siloxane structures, adjusting its viscosity average molecular weight to a specific low range allows sufficiently low surface free energy to be achieved with a smaller amount than conventionally used (i.e., the specific first resin content ratio mentioned above), thereby obtaining good water repellency. Consequently, the low amount of the first resin content suppresses hardness reduction while increasing a contact angle of liquid on the surface of the photoreceptor. This made it difficult for minute components such as paper dust to adhere, enabling the simultaneous achievement of the excellent anti-filming properties and wear resistance.

Furthermore, in the present disclosure, it is preferable that the charge transport layer 3b contain a phthalocyanine pigment. In general, when the photoreceptor is used repeatedly, a residual potential increases, and a print smear may occur due to a surface potential not sufficiently decreasing after exposure. In contrast, incorporating the phthalocyanine pigment into the charge transport layer 3b promotes charge migration, enabling the rapid decay of the surface potential of the photoreceptor and suppressing the print smear. Furthermore, the inclusion of the phthalocyanine pigment allows for stabilization of the surface potential of the photoreceptor during repeated use without compromising the aforementioned wear resistance and anti-filming properties.

In general, a single-layer electrophotographic photoreceptor is known that incorporates a water-repellent polycarbonate resin into a photosensitive layer to more effectively prevent adhesion of silica and paper dust, thereby suppressing filming. To overcome this, the photoreceptor 1 according to an embodiment of the present disclosure described above achieves both the excellent wear resistance and anti-filming properties by including the specific binder resin in the charge transport layer of the laminated photoreceptor, where functions of generating charges and transporting the charges are separated. The overview of the photoreceptor 1 has been described with reference to FIGS. 1 to 3. The detailed configuration of the photoreceptor 1 will now be described.

### <Charge Transport Layer>

The charge transport layer 3b may contain the binder resin containing the first resin and the second resin, and may also contain components other than the hole transport agent, such as additives, as necessary. When the charge transport layer 3b includes two or more layers, it is preferable that the first resin and the second resin be contained in the same layer. The thickness of the charge transport layer 3b is not particularly limited, but it is preferable to be 2 μm or more and 100 μm or less, and more preferably 5 μm or more and 50 μm or less.

### (Binder Resin)

The binder resin is typically configured of the first resin and the second resin. The binder resin may contain other resins besides the first resin and the second resin, provided that the effects of the present disclosure are not impaired. Other binder resins include, for example, thermoplastic resins (more specifically, a styrene-based resin, a styrene-butadiene copolymer, a styrene-acrylonitrile copolymer, a styrene-maleic acid copolymer, a styrene-acrylic acid copolymer, an acrylic copolymer, a polyethylene resin, an ethylene-vinyl acetate copolymer, a chlorinated polyethylene resin, a polyvinyl chloride resin, a polypropylene resin, an ionomer, a vinyl chloride-vinyl acetate copolymer, a polyester resin, an alkyd resin, a polyamide resin, a polyurethane resin, a polysulfone resin, a diallyl phthalate resin, a ketone resin, a polyvinyl butyral resin, a polyvinyl acetal resin, and a polyether resin), thermosetting resins (more specifically, a silicone resin, an epoxy resin, a phenolic resin, a urea resin, a melamine resin, and other crosslinkable thermosetting resins), and light-curable resins (more specifically, an epoxy-acrylic acid resin and a urethane-acrylic acid copolymer).

### (First Resin)

The first resin is a polycarbonate resin containing the repeating units having the siloxane structures (hereinafter also referred to simply as “a siloxane-containing polycarbonate resin”). The repeating units having the siloxane structures have siloxane bonds “—Si—O—” in their main chains. The polycarbonate resin is not particularly limited as long as it contains a carbonate bond in a molecular main chain, for example, having a carbonate bond that links the repeating units having the siloxane structures.

When a total amount of the first resin is 100 mol %, it is preferable that a content ratio of the repeating units having the siloxane structures be 0.5 mol % or more and 20 mol % or less.

As the polycarbonate resin containing the repeating units having the siloxane structures, a polycarbonate resin containing repeating units each having a bond represented by the formula “—Si(CH₃)₂O—” in its main chain is preferred. As the repeating units having the siloxane structures, a polycarbonate resin having the repeating units (polyalkylsiloxane structures) represented by the following formula (a) is more preferred. As the formula (a), the following formula (a1) is preferred.

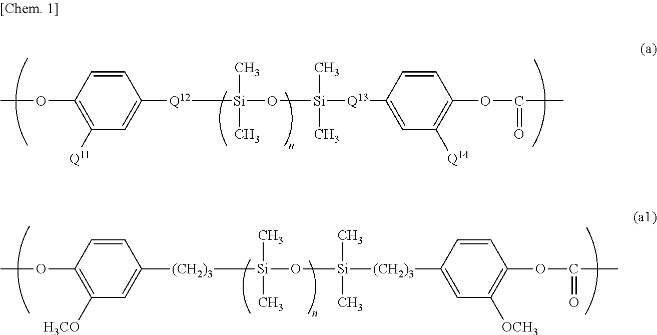

In the formula (a), Q¹¹ and Q¹⁴ each independently represents an alkoxy group having 1 to 6 carbon atoms or an alkyl group having 1 to 6 carbon atoms. Q¹¹ and Q¹⁴ preferably each represents an alkoxy group having 1 to 6 carbon atoms, more preferably represent an alkoxy group having 1 to 3 carbon atoms, and are further preferably a methoxy group. In the formula (a), Q¹² and Q¹³ each independently represents an alkanediyl group having 1 to 6 carbon atoms. Q¹² and Q¹³ each independently preferably represents an alkanediyl group having 2 to 4 carbon atoms, and more preferably represents a propanediyl group. In the formulae (a) and (a1), n represents an integer of 30 or more to 60 or less.

The siloxane-containing polycarbonate resin may have other repeating units. The other repeating units are not particularly limited, but may include repeating units contained in the second resin described below. For example, from the perspective of the wear resistance and compatibility with the second resin described below, it is preferable to contain repeating units represented by formulae (PC-1) and (PC-2), more preferably to contain repeating units represented by formulae (PC-1-1) and (PC-2-1), and even more preferably to contain a terminal group (PC-T).

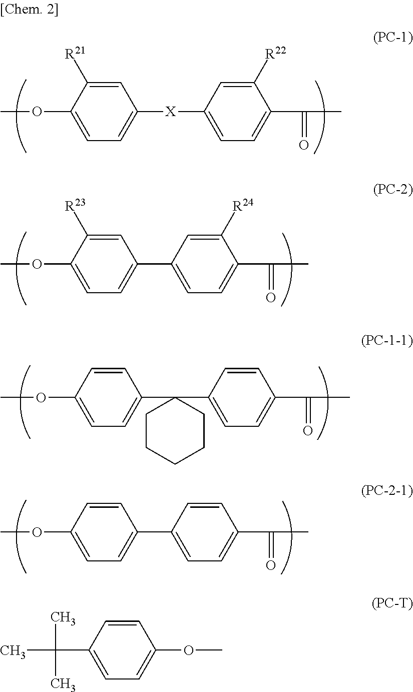

Similarly, from the perspective of the wear resistance and the compatibility with the second resin described below, it is preferable to contain repeating units represented by the formulae (PA-1) and (PA-2) described below, more preferably to contain repeating units represented by the formulae (PA-1-1) and (PA-2-1) or the formula (PA-2-2), and may further contain repeating units represented by formula (PA-3) and/or formula (PA-4).

More specifically, it is further preferred to additionally contain the repeating units represented by the formulae (PA-1-1), (PA-2-1), (PA-3), and (PA-4), or to additionally contain the repeating units represented by formulae (PA-1-1), (PA-2-2), and (PA-4).

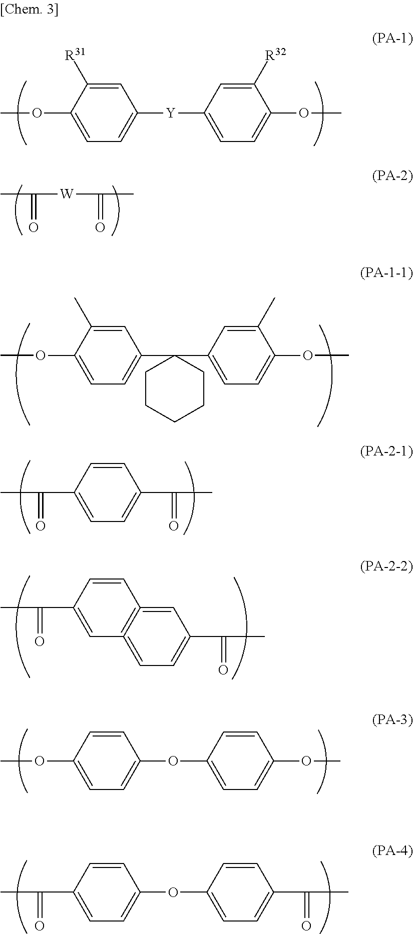

The viscosity average molecular weight of the first resin is preferably 15,000 or more and 20,000 or less to further improve wear resistance and anti-filming properties. The viscosity average molecular weight can be measured according to JIS K7252-1:2016.

The content ratio of the first resin is preferably 10 mass % or more and 25 mass % or less relative to the binder resin, from the perspective of further improving the wear resistance and the anti-filming properties. The content ratio of the first resin of 10 mass % or more allows for a further reduction in the surface free energy, while the content ratio of the first resin of 25 mass % or less enables higher hardness and a greater reduction in wear amount.

### (Second Resin)

The polycarbonate resin and the polyarylate resin, which do not contain the repeating units having the siloxane structures, are not particularly limited, but since they yield the photosensitive layer with an excellent balance of processability, mechanical properties, optical properties, and the wear resistance, the following polycarbonate resin and the polyarylate resin are preferred.

### Polycarbonate Resin

The polycarbonate resin preferably has the repeating units represented by the formula (PC-1) and the formula (PC-2) (hereinafter also referred to simply as “a repeating unit (PC-1)” and “a repeating unit (PC-2)”). Note that the repeating unit (PC-1) and the repeating unit (PC-2) may be the same or different in the first resin and the second resin.

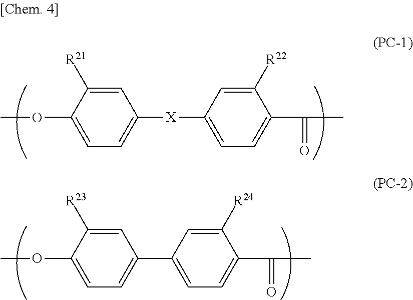

In the above formula (PC-1), R²¹ and R²² each independently represents a hydrogen atom or an alkyl group having 1 to 4 carbon atoms. In the above formula (PC-2), R²³ and R²⁴ in the above formula (PC-2) each independently represents a hydrogen atom or an alkyl group having 1 to 4 carbon atoms, and X represents a divalent group represented by formula (X1) or (X2).

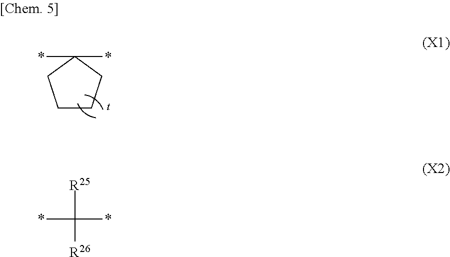

For the alkyl group having 1 to 4 carbon atoms represented by R²¹ and R²² in the formula (PC-1), R²³ and R²⁴ in the formula (PC-2), and R²⁵ and R²⁶ in the formula (X2), a methyl group or an ethyl group are preferred. t in the formula (X1) preferably represents an integer of 1 or more and 2 or less, and more preferably represents 2. A bond represented by * in the formulae (X1) and (X2) is bonded to the carbon atom to which X in the formula (PC-1) is bonded.

R²¹ and R²² in the formula (PC-1) each preferably represents a hydrogen atom or a methyl group. R²³ and R²⁴ in the formula (PC-2) each preferably represents a hydrogen atom. X in the formula (PC-2) preferably represents a divalent group represented by the formula (X1). t in the formula (X1) preferably represents 2.

As the polycarbonate resin having the repeating units represented by the formulae (PC-1) and (PC-2), for example, a polycarbonate resin having the repeating units represented by the formulae (PC-1-1) and (PC-2-1) is mentioned.

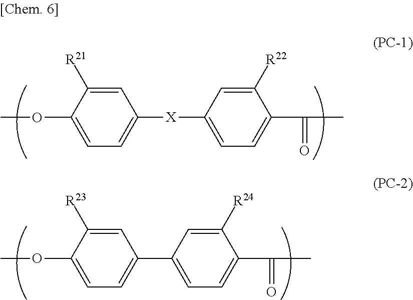

The polycarbonate resin may have the terminal group represented by the formula (PC-T).

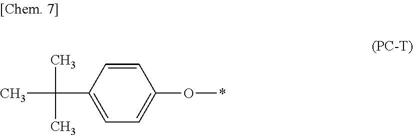 [SMILES: *Oc1ccc(C(C)(C)C)cc1]

In the formula (PC-T), * represents a bond to the repeating unit represented by the formula (PC-1) or the formula (PC-2). The bond represented by * is directly bonded to a —CO— group, which is one end of the repeating unit represented by the formula (PC-1) and the formula (PC-2). Furthermore, the bond represented by * is bonded to a —O— group, which is the other end of the repeating unit represented by the formula (PC-1) or the formula (PC-2), via a carbonyl group.

From the perspective of improving the wear resistance, it is preferable that the polycarbonate resin contain the repeating unit (PC-1-1) and the repeating unit (PC-2-1), and it is more preferable that the polycarbonate resin further contain the terminal group (PC-T).

The polycarbonate resin may additionally contain repeating units other than the repeating units (PC-1) and (PC-2) as the repeating units. However, to improve solubility in solvents and enhance the wear resistance of the photoreceptor when contained in the photosensitive layer, the content ratio of the repeating units (PC-1) and (PC-2) in the total number of the repeating units present in the polycarbonate resin is preferably 90% or more, more preferably 95% or more, further preferably 99% or more, and particularly preferably 100%. That is, it is particularly preferable that the polyarylate resin contain only the repeating units (PC-1) and (PC-2) as the repeating units.

### Polyarylate Resin

The polyarylate resin preferably has the repeating units represented by the formula (PA-1) and the formula (PA-2) (hereinafter also referred to simply as “a repeating unit (PA-1) and a repeating unit (PA-2)”). Note that the repeating unit (PA-1) and the repeating unit (PA-2) may be the same or different in the first resin and the second resin.

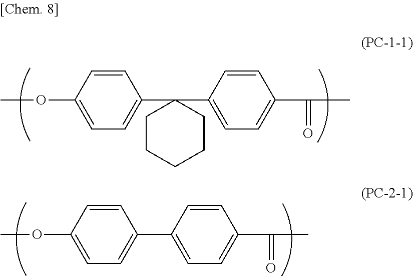

In the above formula (PA-1), R³¹ and R³² each independently represent a hydrogen atom or a methyl group, and Y represents a divalent group represented by the formula (Y1) or (Y2). In the above formula (PA-2), W represents a divalent group represented by formula (W1) or (W2).

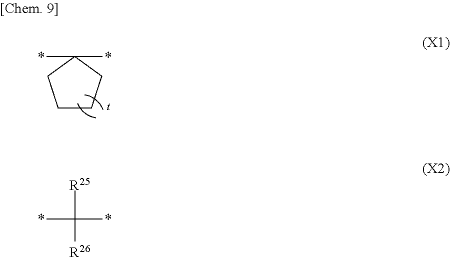

In the above formula (Y1), s represents an integer of 1 or more and 3 or less, and * represents a bond. In the above formula (Y2), R³³ and R³⁴ each represents a hydrogen atom or an alkyl group having 1 or more and 4 or fewer carbon atoms, R³³ and R³⁴ represent mutually different groups, and * represents a bond.

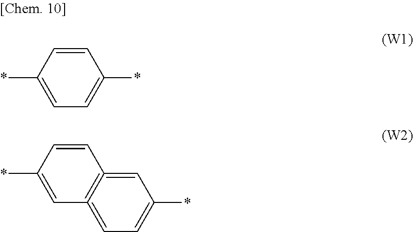

In the above formulae (W1) and (W2), * each represents a bond.

In the formula (PA-1), R³¹ and R³² each preferably represents a methyl group.

In the formula (Y1), s preferably represents 2.

In the formula (Y2), it is preferable that R³³ represent a hydrogen atom and R³⁴ represent a methyl group, an ethyl group, or an alkyl group having 3 carbon atoms; that R³³ represent a methyl group and R³⁴ represents an ethyl group or an alkyl group having 3 carbon atoms; or that R³³ represent a methyl group and R³⁴ represent an alkyl group having 3 carbon atoms. It is more preferred that R³³ represent a methyl group and R³⁴ represents an ethyl group.

The bond represented by * in the formulae (Y1) and (Y2) is bonded to the carbon atom to which Y is bonded in the formula (PA-1). The bond represented by * in the formulae (W1) and (W2) is bonded to the carbon atom to which W is bonded in the formula (PA-2).

As a polyarylate resin, it may be a polyarylate resin (PA1) having the repeating units represented by the following formula (PA-1-1) and formula (PA-2-1), or it may be a polyarylate resin (PA2) having the repeating units represented by the following formula (PA-1-1) and formula (PA-2-2). The repeating units represented by the formula (PA-1-1), the formula (PA-2-1), and the formula (PA-2-2) are also referred to simply as “a repeating unit (PA-1-1),” “a repeating unit (PA-2-1),” and “a repeating unit (PA-2-2),” respectively.

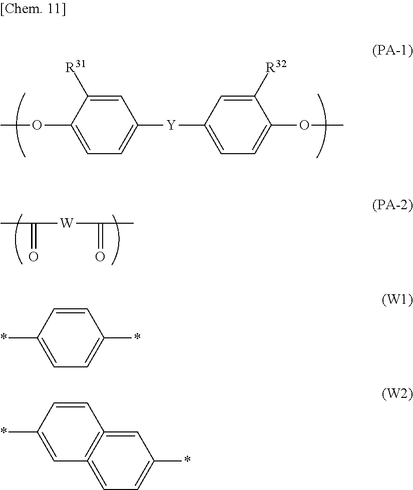

The polyarylate resin (PA) may further have repeating units other than the repeating units (PA-1) and (PA-2) as the repeating units. For example, it may contain the following formula (PA-3) and/or (PA-4).

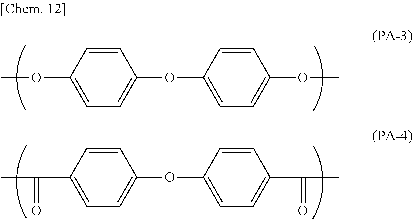

From the perspective of improving the wear resistance, the polyarylate resin is preferably the polyarylate resin having the repeating units represented by the repeating units (PA-1-1), (PA-2-1), (PA-3), and (PA-4), or the polyarylate resin having the repeating units represented by the repeating units (PA-1-1), (PA-2-2), and (PA-4). Each of the above polyarylate resins is a resin that does not contain the above repeating unit (a).

The polyarylate resin (PA) may have a terminal group. Examples of the terminal group that polyarylate resin (PA) may possess include those represented by formulae (PA-T1) and (PA-T2). As the terminal group represented by the formula (PA-T1), the terminal group represented by a formula (T-DMP) (hereinafter sometimes referred to as a terminal group (T-DMP)) is preferred. As the terminal group represented by the formula (PA-T2), the terminal group represented by a formula (T-PFH) (hereinafter sometimes referred to as a terminal group (T-PFH)) is preferred.

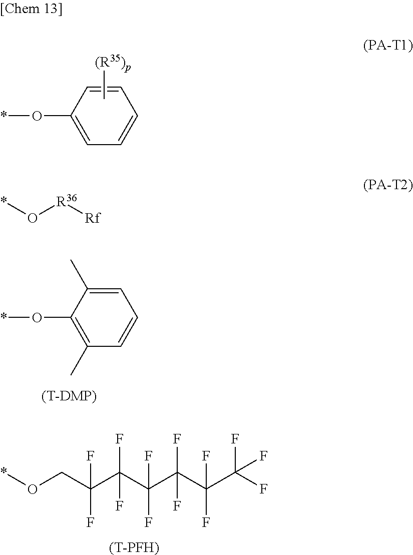

In the formula (PA-T1), R³⁵ represents an alkyl group having 1 to 6 carbon atoms or a halogen atom, and p represents an integer of 0 or more to 5 or less. R³⁵ preferably represents an alkyl group having 1 to 6 carbon atoms, more preferably represents an alkyl group having 1 to 3 carbon atoms, and most preferably represents a methyl group. p preferably represents an integer of 1 or more to 3 or less, and more preferably represents 2.

In the formula (PA-T2), R³⁶ represents an alkanediyl group having 1 to 6 carbon atoms, and Rf represents a perfluoroalkyl group having 1 to 10 carbon atoms. R³⁶ preferably represents an alkanediyl group having 1 to 3 carbon atoms, and more preferably represents a methylene group. Rf preferably represents a perfluoroalkyl group having 3 to 10 carbon atoms, more preferably represents a perfluoroalkyl group having 5 to 7 carbon atoms, and even more preferably represents a perfluoroalkyl group having 6 carbon atoms.

* in the formulae (PA-T1), (PA-T2), (T-DMP), and (T-PFH) indicate the bond. The bond indicated by * in the formulae (PA-T1), (PA-T2), (T-DMP), and (T-PFH) is bonded to a repeating unit derived from a dicarboxylic acid located at a terminal end of the polyarylate resin (PA) (more specifically, to the repeating unit (PA-2-1) or (PA-2-2)).

To further improve the wear resistance of the photoreceptor, it is preferable that the second resin, the polyarylate resin (PA), have a terminal group containing a halogen atom.

An example of the terminal group having the halogen atom is the terminal group (PA-T1) where R³⁵ in the formula (PA-T1) represents the halogen atom. Another example of the terminal group having the halogen atom is the terminal group (PA-T2).

In the polyarylate resin (PA), the repeating unit derived from bisphenol (more specifically, the repeating unit (PA-1) or (PA-3)) and the repeating unit derived from dicarboxylic acid (more specifically, the repeating unit (PA-2) or (PA-4)) are bonded to each other in a neighboring manner. That is, the repeating unit (PA-1) may be bonded to the repeating unit (PA-2) or to the repeating unit (PA-4). Furthermore, the repeating unit (PA-2) may be bonded to the repeating unit (PA-1) or to the repeating unit (PA-4). The number of the repeating units derived from bisphenol is approximately equal to the number of the repeating units derived from dicarboxylic acid, satisfying the calculation formula “the number of the repeating units derived from dicarboxylic acid=the number of the repeating units derived from bisphenol+1.” The polyarylate resin (PA1) may be, for example, a random copolymer, an alternating copolymer, a periodic copolymer, or a block copolymer.

The polyarylate resin (PA) may have only one type of the repeating unit (PA-1) as the repeating unit (PA-1), or may have two or more types (e.g., two types) of the repeating units (PA-1). The polyarylate resin (PA) may have only one type of the repeating unit (PA-2) as the repeating unit (PA-2), or may have two types of the repeating units (PA-2).

The polyarylate resin may further contain repeating units other than the repeating units (PA-1) to (PA-4) as the repeating units. However, to improve the solubility in solvents and enhance the wear resistance of the photoreceptor when contained in the photosensitive layer, the content ratio of the repeating units (PA-1) to (PA-4) to the total number of the repeating units contained in the polyarylate resin is preferably 90% or more, more preferably 95% or more, further preferably 99% or more, and particularly preferably 100%. That is, it is particularly preferable that the polyarylate resin contains only the repeating units (PA-1) to (PA-4) as the repeating units.

### (Hole Transport Agent)

Examples of the hole transport agent include, for example, a triphenylamine derivative, a diamine derivative (e.g., an N,N,N′,N′-tetraphenylbenzidine derivative, an N,N,N′,N′-tetraphenylphenylene diamine derivative, an N,N,N′,N′-tetraphenylnaphthylenediamine derivative, an N,N,N′,N′-tetraphenylphenanthrenediamine derivative, and a di(aminophenylvinyl)benzene derivative), an oxadiazole compound (e.g., 2,5-di(4-methylaminophenyl)-1,3,4-oxadiazole), a styryl compound (e.g., 9-(4-diethylaminostyryl) anthracene), a carbazole compound (e.g., polyvinylcarbazole), an organic polysilane compound, a pyrazoline-based compound (e.g., 1-phenyl-3-(p-dimethylaminophenyl) pyrazoline), a hydrazone-based compound, an indole-based compound, an oxazole-based compound, an isoxazole-based compound, a thiazole-based compound, a thiadiazole-based compound, an imidazole-based compound, a pyrazole-based compound, and a triazole-based compound. The photosensitive layer may contain only one type of the hole transport agent or may contain two or more types of the hole transport agents.

Preferred examples of the hole transport agents, from the perspective of obtaining the excellent anti-filming properties and wear resistance, include compounds represented by formulae (20), (21), (22), and (23) (hereinafter sometimes referred to as hole transport agents (20), (21), (22), and (23)).

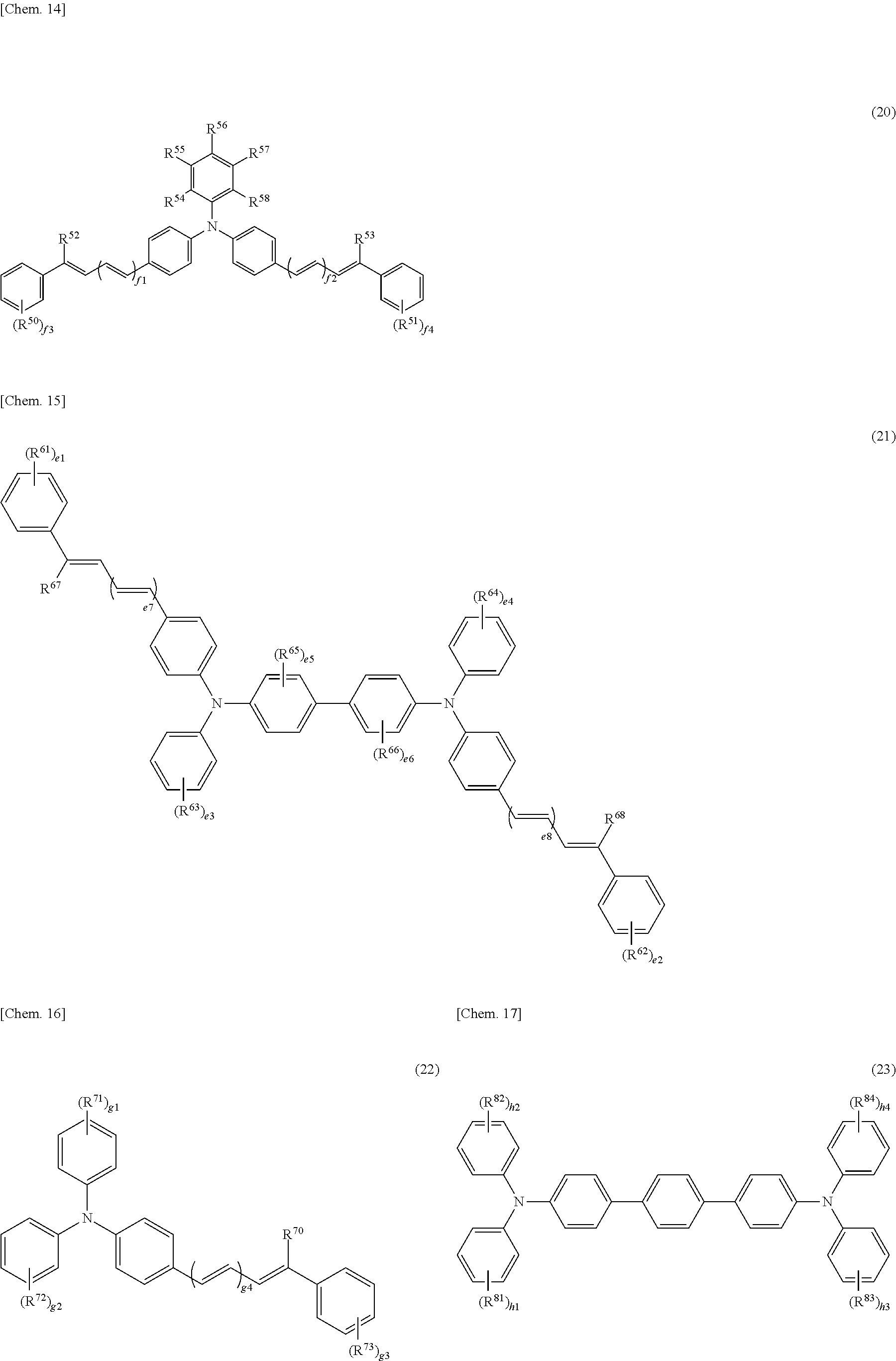

A content of the hole transport agent is preferably 10 mass parts or more and 200 mass parts or less per 100 mass parts of binder resin, more preferably 20 mass parts or more and 100 mass parts or less, and most preferably 40 mass parts or more and 60 mass parts or less.

In the formula (20), R⁵⁰ and R⁵¹ each independently represents an alkyl group having 1 to 6 carbon atoms, an alkoxy group having 1 to 6 carbon atoms, or a phenyl group. R⁵², R⁵³, R⁵⁴, R⁵⁵, R⁵⁶, R⁵⁷, and R⁵⁸ each independently represents a hydrogen atom, an alkyl group having 1 to 6 carbon atoms, an alkoxy group having 1 to 6 carbon atoms, or a phenyl group which may be substituted by an alkyl group having 1 to 6 carbon atoms. f1 and f2 each independently represents an integer of 0 or more and 2 or less. f3 and f4 each independently represents an integer of 0 or more and 5 or less.

In the formula (20), when f3 represents an integer of 2 or more to 5 or less, a plurality of R⁵⁰ groups may represent the same group or different groups. When f4 represents an integer of 2 or more and 5 or less, a plurality of the R⁵¹ groups may represent the same group or different groups.

In the formula (20), it is preferable that R⁵⁰ and R⁵¹ each independently represent an alkyl group having 1 to 6 carbon atoms. It is preferable that R⁵² and R⁵³ each represent a phenyl group which may be substituted with a hydrogen atom or an alkyl group having 1 to 6 carbon atoms. It is preferable that R⁵⁴ to R⁵⁸ each independently represent an alkyl group having 1 to 6 carbon atoms. R⁵⁴ to R⁵⁸ each independently represents a hydrogen atom, an alkyl group having 1 to 6 carbon atoms, or an alkoxy group having 1 to 6 carbon atoms. f1 and f2 each preferably represents 0, each represents 1, or each represents 2. f3 and f4 each independently preferably represents 0 or 1.

The alkyl group having 1 to 6 carbon atoms represented by R⁵⁰ and R⁵¹ is preferably an alkyl group having 1 to 3 carbon atoms, and more preferably the methyl group. The phenyl group which may be substituted with the alkyl group having 1 to 6 carbon atoms represented by R⁵² and R⁵³ is preferably a phenyl group or a phenyl group substituted with an alkyl group having 1 to 3 carbon atoms. The phenyl group substituted with the alkyl group having 1 to 3 carbon atoms is preferably a methylphenyl group, and more preferably a 4-methylphenyl group. The alkyl group having 1 to 6 carbon atoms represented by R⁵⁴ to R⁵⁸ is preferably an alkyl group having 1 to 4 carbon atoms, and more preferably a methyl group, an ethyl group, or an n-butyl group. The alkoxy group having 1 to 6 carbon atoms represented by R⁵⁴ to R⁵⁸ is the alkoxy group having 1 to 3 carbon atoms, and more preferably an ethoxy group.

In the formula (21), R⁶¹, R⁶², R⁶³, R⁶⁴, R⁶⁵, and R⁶⁶ each independently represents an alkyl group having 1 to 8 carbon atoms or a phenyl group. R⁶⁷ and R⁶⁸ independently represents a hydrogen atom, an alkyl group having 1 to 8 carbon atoms, or a phenyl group. e1, e2, e3, and e4 each independently represents an integer of 0 or more to 5 or less. e5 and e6 each independently represents an integer of 0 or more to 4 or less. e7 and e8 each independently represents 0 or 1.

In the formula (21), when the e1 represents an integer of 2 or more to 5 or less, a plurality of R⁶¹ groups may represent the same group or different groups. When the e2 represents an integer of 2 or more to 5 or less, a plurality of R⁶² may represent the same group or different groups. When the e3 represents an integer of 2 or more and 5 or less, a plurality of R⁶³ may represent the same group or different groups. When the e4 represents an integer of 2 or more and 5 or less, a plurality of R⁶⁴ may represent the same group or different groups. When the e5 represents an integer of 2 or more and 4 or less, a plurality of R⁶⁵ may represent the same group or different groups. When the e6 represents an integer of 2 or more and 4 or less, a plurality of R⁶⁶ may represent the same group or different groups.

In the formula (21), R⁶¹ to R⁶⁶ each independently represents an alkyl group having 1 to 8 carbon atoms, more preferably represents an alkyl group having 1 to 3 carbon atoms, and most preferably represents a methyl or ethyl group. R⁶⁷ and R⁶⁸ preferably represents a hydrogen atom. The e1, the e2, the e3, and the e4 each independently preferably represents an integer of 0 or more and 2 or less. The e5 and the e6 each preferably represents 0.

In the formula (22), R⁷⁰ represents a hydrogen atom, an alkyl group having 1 to 8 carbon atoms, an alkoxy group having 1 to 8 carbon atoms, or a phenyl group which may be substituted by an alkyl group having 1 to 8 carbon atoms. R⁷¹, R⁷², and R⁷³ each independently represents an alkyl group having 1 to 8 carbon atoms or an alkoxy group having 1 to 8 carbon atoms. g1, g2, and g3 each independently represents an integer of 0 or more to 5 or less. g4 represents 0 or 1.

In the formula (22), when the g1 represents an integer of 2 or more to 5 or less, a plurality of R⁷¹ groups may represent the same group or different groups. When the g2 represents an integer of 2 or more to 5 or less, a plurality of R⁷² may represent the same group or different groups. When the g3 represents an integer of 2 or more and 5 or less, a plurality of R⁷³ may represent the same group or different groups.

In the formula (22), R⁷⁰ preferably represents a phenyl group. R⁷¹, R⁷², and R⁷³ each independently represents an alkyl group having 1 to 8 carbon atoms, more preferably represent an alkyl group having 1 to 3 carbon atoms, and most preferably represent a methyl group. The g1 and the g2 each preferably represents 1. The g3 preferably represents 0. As already stated, the g4 represents 0 or 1.

In the formula (23), R⁸¹, R⁸², R⁸³, and R⁸⁴ each independently represents an alkyl group having 1 to 6 carbon atoms or an alkoxy group having 1 to 6 carbon atoms. h1, h2, h3, and h4 each independently represents an integer of 0 or more and 5 or less.

In the formula (23), when the h1 represents an integer of 2 or more and 5 or less, a plurality of R⁸¹ may represent the same group or different groups. When the h2 represents an integer of 2 or more and 5 or less, a plurality of R⁸² may represent the same group or different groups. When the h3 represents an integer of 2 or more and 5 or less, a plurality of the R⁸³ may represent the same group or different groups. When the h4 represents an integer of 2 or more and 5 or less, a plurality of the R⁸⁴ may represent the same group or different groups.

In the formula (23), R⁸¹, R⁸², R⁸³, and R⁸⁴ each independently represents an alkyl group having 1 to 3 carbon atoms, preferably a methyl or ethyl group. The h1, h2, h3, and h4 each independently represents an integer of 1 or more to 3 or less, and preferably represents 1.

Preferred examples of the hole transport agent include compounds represented by formulae (H-1) to (H-7) (hereinafter referred to as hole transport agents (H-1) to (H-7), respectively). In the hole transport agent (H-5), a1, a2, or a3 is an integer of 0 or 1, and at least one of a1, a2, and a3 is an integer of 1. That is, the hole transport agent (H-5) is a tetraphenylenediamine derivative having a methyl substituent number of 2-substituted, 3-substituted, or 4-substituted, and mixtures thereof are also acceptable.

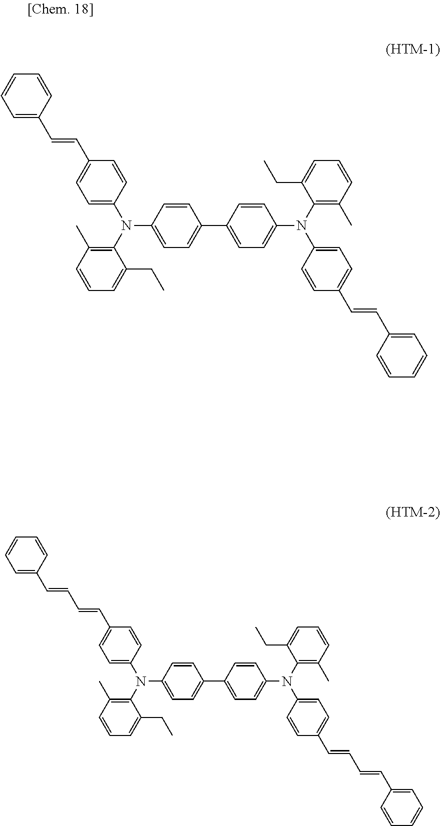 [SMILES: CCc1cccc(C)c1N(c1ccc(/C=C/c2ccccc2)cc1)c1ccc(-c2ccc(N(c3ccc(/C=C/c4ccccc4)cc3)c3c(C)cccc3CC)cc2)cc1 ; CCc1cccc(C)c1N(c1ccc(/C=C/C=C/c2ccccc2)cc1)c1ccc(-c2ccc(N(c3ccc(/C=C/C=C/c4ccccc4)cc3)c3c(C)cccc3CC)cc2)cc1]

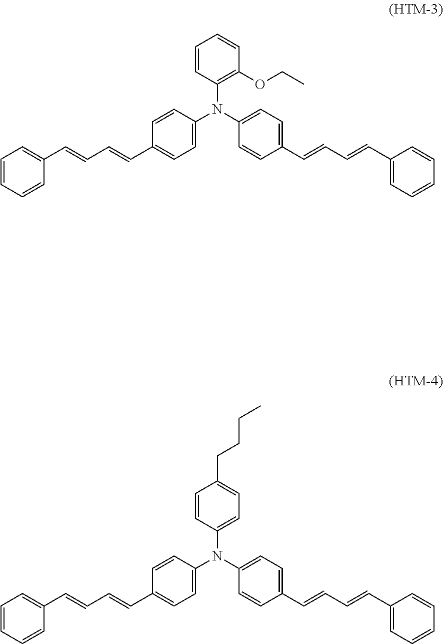 [SMILES: CCOc1ccccc1N(c1ccc(/C=C/C=C/c2ccccc2)cc1)c1ccc(/C=C/C=C/c2ccccc2)cc1 ; CCCCc1ccc(N(c2ccc(/C=C/C=C/c3ccccc3)cc2)c2ccc(/C=C/C=C/c3ccccc3)cc2)cc1]

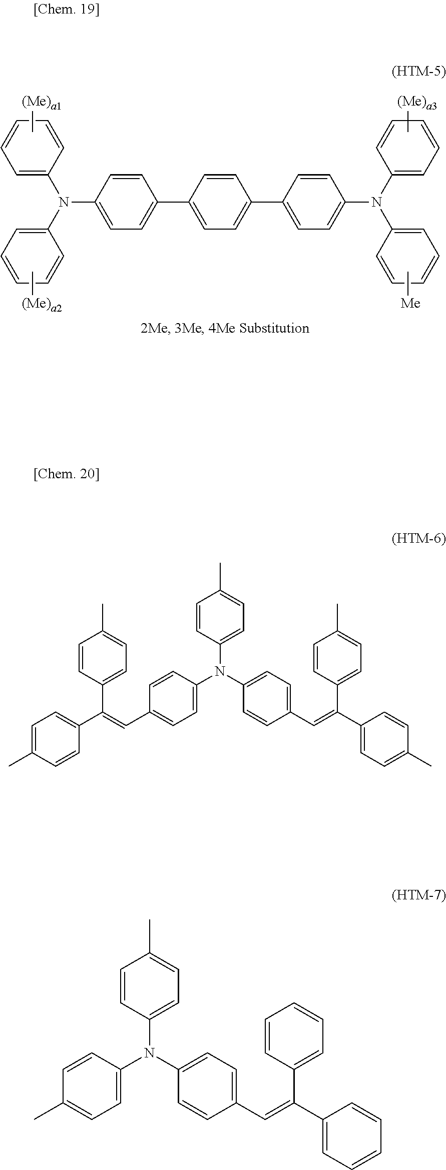

### (Phthalocyanine Pigment)

The phthalocyanine pigment that may be contained in the charge transport layer is a metal-free phthalocyanine or a compound represented by a formula (1). Hereinafter, the “compound represented by the formula (1)” may be referred to as “a phthalocyanine pigment (1).” Furthermore, “the metal-free phthalocyanine or the phthalocyanine pigment (1)” may be referred to as “a specified phthalocyanine pigment.” The inclusion of the specified phthalocyanine pigment in the charge transport layer improves sensitivity characteristics, thereby suppressing the print smear and enabling formation of a high-quality image.

First, the phthalocyanine pigment (1) will be described. In the following formula (1), M represents a metal atom that may have a ligand.

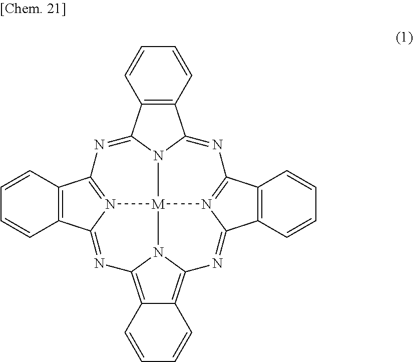

In the formula (1), the metal atom represented by M preferably represents a titanium atom, a gallium atom, a copper atom, a zinc atom, or a lead atom; more preferably represents a titanium atom or gallium atom; and most preferably represents a titanium atom.

In the formula (1), the metal atom represented by M may have a ligand. Such ligand includes, for example, an alkyl group having 1 to 6 carbon atoms, an alkoxy group having 1 to 6 carbon atoms, an aryloxy group having 6 to 14 carbon atoms, a halogen atom, a hydroxyl group, and an oxo group (═O). When a ligand other than the oxo group coordinates, two ligands may coordinate to the metal atom. As the ligand, a halogen atom (more preferably, a chlorine atom), a hydroxyl group, or an oxo group is preferred.

In the formula (1), M preferably represents a titanium atom that may have a ligand, a gallium atom that may have a ligand, a copper atom that may have a ligand, a zinc atom that may have a ligand, or a lead atom that may have a ligand; more preferably a titanium atom that may have a ligand or a gallium atom that may have a ligand; and further preferably a titanium atom having a ligand or a gallium atom having a ligand. As the titanium atom having the ligand, it is preferable to represent a titanium atom having an oxygen atom as the ligand (i.e., TiO). As the gallium atom having the ligand, a gallium atom having a chlorine atom as the ligand (i.e., GaCl) or a gallium atom having a hydroxyl group as the ligand (i.e., GaOH) is preferred.

The phthalocyanine pigment (1) may be crystalline or non-crystalline. As the phthalocyanine pigment (1), for example, titanyl phthalocyanine, hydroxygallium phthalocyanine, or chlorogallium phthalocyanine are preferred, and titanyl phthalocyanine is more preferred. Titanyl phthalocyanine is a compound represented by a formula (K-1) (hereinafter sometimes referred to as a phthalocyanine pigment (K-1)). Although it is identical to a formula (CG-1) described later, to distinguish them, the titanyl phthalocyanine contained in the charge transport layer is represented by the formula (K-1), and the titanyl phthalocyanine contained in the charge generation layer is represented by the formula (CG-1). Examples of titanyl phthalocyanine crystals include α-type, β-type, and Y-type titanyl phthalocyanines.

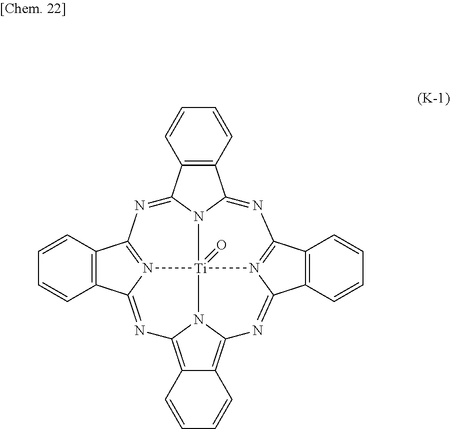

Next, the metal-free phthalocyanine will be described. The metal-free phthalocyanine is a compound represented by a formula (K-2) (hereinafter sometimes referred to as a phthalocyanine pigment (K-2)). Although the formula (K-2) is identical to a formula (CGM-2) described later, to distinguish them, the metal-free phthalocyanine contained in the charge transport layer is represented by the formula (K-2), and the metal-free phthalocyanine contained in the charge generation layer is represented by the formula (CGM-2). The metal-free phthalocyanine may be crystalline or non-crystalline. Examples of crystalline metal-free phthalocyanine include X-type metal-free phthalocyanine.

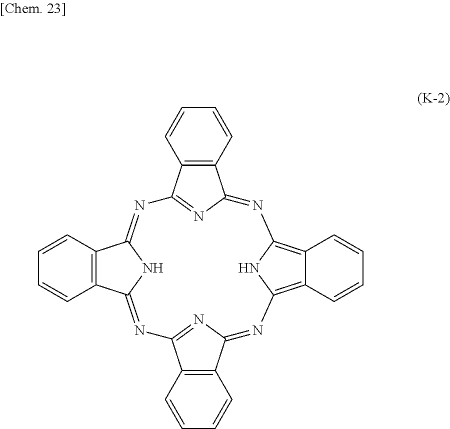 [SMILES: c1ccc2c(c1)-c1nc-2nc2[nH]c(nc3nc(nc4[nH]c(n1)c1ccccc41)-c1ccccc1-3)c1ccccc21]

A content of the specified phthalocyanine pigment is preferably 0.1 parts by mass or more and 1.0 parts by mass or less, and is preferably 0.15 parts by mass or more and 0.7 parts by mass or less per 100 mass parts of the binder resin.

When the photoreceptor is exposed, charges tend to be generated not only from a charge generating agent contained in the charge generation layer but also from the specified phthalocyanine pigment contained in the charge transport layer. Therefore, the inclusion of the specified phthalocyanine pigment in the charge transport layer increases the sensitivity characteristics of the photoreceptor, making it easier to form an excellent image with less print smear. Furthermore, this effect becomes pronounced when the content of the specified phthalocyanine pigment is 0.15 parts by mass or more per 100 parts by mass of the binder resin.

On the other hand, when the content of the specified phthalocyanine pigment exceeds 1.0 parts by mass per 100 parts by mass of the binder resin, there is a tendency for exposure light to be blocked by the charge transport layer and have difficulty reaching the charge generation layer when the photoreceptor is exposed. When the content of the specified phthalocyanine pigment is 1.0 parts by mass or less per 100 parts by mass of the binder resin, the exposure light is less likely to be blocked by the charge transport layer and reaches the charge generation layer effectively. Furthermore, when the content is 0.1 parts by mass or more, the sensitivity characteristics of the photoreceptor are readily improved sufficiently. As a result, an excellent image with less print smear is formed.

The charge transport layer may contain only one type of either the metal-free phthalocyanine or the phthalocyanine pigment (1), or may contain two or more types. When two or more types of the metal-free phthalocyanine and the phthalocyanine pigment (1) are contained, a content of the specified phthalocyanine pigment refers to a total content of the two or more types of the metal-free phthalocyanine and the phthalocyanine pigment (1).

To further improve the sensitivity characteristics of the photoreceptor, it is preferable that the specified phthalocyanine pigment contained in the charge transport layer be the same as the charge generating agent contained in the charge generation layer.

### (Surface Free Energy of Photosensitive Layer)

The surface free energy of the photosensitive layer is preferably 25.0 mN/m or less. Filming occurs due to the adhesion of toner components to the surface of the photoreceptor. Keeping the surface free energy of the photosensitive layer at 25.0 mN/m or less suppresses the adhesion of toner components such as silica. The surface free energy was calculated from the contact angles of water, polyethylene glycol, and tricresyl phosphate.

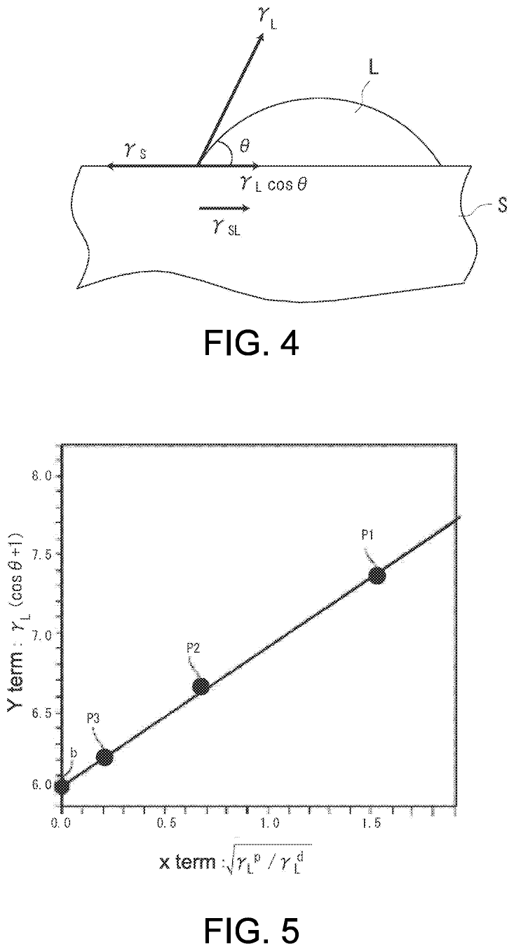

To aid understanding, an overview of a method for calculating surface free energy of solids is provided before describing a method for measuring the surface free energy of the photosensitive layer. The surface free energy of solids is calculated based on the Owens-Wendt method. This is described below with reference to FIG. 4. FIG. 4 is a diagram illustrating the Young's equation. FIG. 4 shows a solid S and a liquid L in contact with the solid S. The surface free energy of the solid S corresponds to a surface tension of the solid S. When the solid S and the liquid L are in contact, a surface tension γ_{S} of the solid, a surface tension γ_{L} of the liquid, and an interfacial tension YSL between the liquid and solid act. Therefore, the surface tension γ_{S} of the solid S is expressed by the following equation (A). The equation (A) is called the Young's equation.

γ_{S}=γ_{L} cos θ+γ_{SL} (A)

In the equation (A), γ_{S} represents the surface tension of the solid S, γ_{L} represents the surface tension of the liquid L, θ represents the contact angle between the liquid L and the solid S, and γ_{SL} represents the interfacial tension between the liquid L and the solid S.

The equation (C) is derived from the equation (A) and the following equation (B), and the equation (C) is transformed into the equation (D). The equation (B) is called the Dupré equation, and the equations (C) and (D) are called the Young-Dupré equations.

$$γ ( SL ) = {γ}_{S} + {γ}_{L} - WA \qquad ( B )$$

$${γ}_{L} ( cos θ + 1 ) = WA \qquad ( C )$$

$$\begin{matrix}[ Math . 1 ] & \\ {γ}_{L} ( cos θ + 1 ) = \sqrt{{γ}_{S}^{d}} + \sqrt{{γ}_{S}^{p}} \cdot \sqrt{\frac{{γ}_{L}^{pq}}{{γ}_{L}^{d}}} & ( D )\end{matrix}$$

In the equation (B), γ_{S}^{L}, γ_{S}, and γ_{L} are synonymous with γ_{S}^{L}, γ_{S}, and γ_{L} respectively in the equation (A), and WA represents a work done by adhesion. In the equation (C), γ_{L} and θ are synonymous with γ_{L} and θ in the equation (A), respectively, and WA is synonymous with the WA in the equation (B). In the equation (D), γ_{L} and θ are synonymous with γ_{L} and θ in the equation (A), respectively. γ_{S}^{d} represents a dispersion component of the solid S, γ_{S}^{p} represents a polar component of the solid S, and γ_{L}^{d} represents a dispersion component of the liquid L, and γ_{L}^{p} represents a polarity component of the liquid L.

When the surface tension γ_{L} of the liquid L, the dispersion component γ_{L}^{d} of the liquid L, and the polar component γ_{L}^{p} are known, the dispersion component γ_{S}^{d} of the solid and the polarity component γ_{S}^{p} of the solid can be calculated based on the equation (D) by measuring the contact angle θ between liquid L and the solid S.

From the calculated dispersion component γ_{S}^{d} of the solid and the calculated polarity component γ_{S}^{p} of the solid, the surface tension γ_{S} of the solid S (equivalent to the surface free energy of the solid S) is calculated based on the equation (E).

γ_{S}=γ_{S}^{d}+γ_{S}^{p} (E)

In the equation (E), γ_{S} is synonymous with γ_{S} in the equation (A), and γ_{S}^{d} and γ_{S}^{p} are synonymous with γ_{S}^{d} and γ_{S}^{p} in the equation (D), respectively. Thus, by measuring the contact angle θ between the liquid L and the solid S, the surface tension γ_{S} of the solid S, and consequently the surface free energy of solid S, can be calculated. The above is the outline of the method for calculating the surface free energy of the solid S.

Next, the method for measuring the surface free energy of the photosensitive layer is described. In this embodiment, the Solid S corresponds to the photosensitive layer. In this embodiment, three types of the liquids L are used: water, polyethylene glycol (hereinafter sometimes referred to as PEG), and tricresyl phosphate. The surface tension γ_{L}, the dispersion component γ_{L}^{d}, and the polar component γ_{L}^{p} of water, PEG, and tricresyl phosphate are known values shown in Table 1.

TABLE 1

| | Surface | Surface | Surface |
|---|---|---|---|
| | tension γ_{L} | tension γ_{L}^{d} | tension γ_{L}^{p} |
| Liquid | [mN/m] | [mN/m] | [mN/m] |
| Water | 72.8 | 21.8 | 51.0 |
| PEG | 43.5 | 29.9 | 13.6 |
| Tricresyl phosphate | 40.9 | 39.2 | 1.7 |

The reasons for using water, PEG, and tricresyl phosphate as the three types of the liquids L are as follows: Specifically, using water as the liquid L allows confirmation of an effect of atmospheric humidity on the photoreceptor. Using PEG, the organic compound, as the liquid L allows confirmation of an effect of organic members in contact with the photoreceptor (e.g., a cleaning blade and a charging roller containing an organic resin). Using tricresyl phosphate, an inorganic substance, as the liquid L allows confirmation of an effect of inorganic matters contacting the photoreceptor (e.g., a toner additive). Thus, using these three types of the liquids L, water, PEG, and tricresyl phosphate, enables derivation of the surface free energy of the photosensitive layer that is optimal for various factors affecting the photoreceptor.

Here, the above equations (D) and (E) can be rewritten as equations (D′) and (E′), respectively. The Y, X, a, and b in the equations (D′) and (E′) are expressed by equations (F1) to (F4), respectively.

$$Y = aX + b \qquad ( {D}^{′} )$$

$${γ}_{S} = b 2 + a 2 \qquad ( {E}^{′} )$$

$$\begin{matrix}[ Math . 2 ] & \\ Y = {γ}_{⌊} ( cos θ + 1 ) & ( F 1 )\end{matrix}$$

$$X = \sqrt{\frac{{γ}_{⌊}^{p}}{{γ}_{⌊}^{d}}} \qquad ( F 2 )$$

$$a = \sqrt{{γ}_{s}^{p}} \qquad ( F 3 )$$

$$b = \sqrt{{γ}_{s}^{d}} \qquad ( F 4 )$$

First, using a contact angle measuring device, the contact angle between water and the photosensitive layer is calculated, and the measured contact angle is defined as a first contact angle. Details of a method for measuring the first contact angle, as well as a second contact angle and a third contact angles will be described later in Examples below. Based on the measured first contact angle and the surface tension γ_{L} of water shown in Table 1, the value of Y for the liquid L being water is calculated using the equation (F1). Based on the dispersion component γ_{L}^{d} of water shown in Table 1 and the polarity component γ_{L}^{p} of water shown in Table 1, the value of X for the liquid L being water is calculated using the equation (F2).

Next, using the contact angle measuring device, the contact angle between PEG and the photosensitive layer is measured, and the measured contact angle is defined as the second contact angle. Based on the measured second contact angle and the surface tension γ_{L} of PEG shown in Table 1, the value of Y when the liquid L is PEG is calculated using the equation (F1). Based on the dispersion component γ_{L}^{d} of PEG shown in Table 1 and the polarity component γ_{L}^{p} of PEG shown in Table 1, the value of X for the liquid L being PEG is calculated using the equation (F2).

Next, using the contact angle measuring device, the contact angle between tricresyl phosphate and the photosensitive layer is measured, and the measured contact angle is defined as the third contact angle. Based on the measured third contact angle and the surface tension γ_{L} of tricresyl phosphate shown in Table 1, the value of Y when the liquid L is tricresyl phosphate is calculated using the equation (F1). Based on the dispersion component γ_{L}^{d} of tricresyl phosphate shown in Table 1 and the polar component γ_{L}^{p} of tricresyl phosphate shown in Table 1, the value of X when the liquid L is tricresyl phosphate is calculated using the equation (F2).

Next, a graph is created with the X value (X term) on the horizontal axis and the Y value (Y term) on the vertical axis. An example of the graph is shown in FIG. 5. FIG. 5 is a graph illustrating the method for calculating the surface free energy. Values of X and Y when the liquid L is water are plotted as a point P1. Values of X and Y when the liquid L is PEG are plotted as a point P2. Values of X and Y when the liquid L is tricresyl phosphate is plotted as a point P3. Then, an approximate straight line for the plotted points P1 to P3 is obtained. An approximation method may employ, for example, the least squares method.

An Y-intercept of the obtained approximation line is read to obtain the value of b in the equation (D′). The Y-intercept is the Y-coordinate at the intersection of the approximation line and the Y-axis (b in FIG. 5). An slope of the obtained approximation line is read to obtain the value of a in the equation (D′). Based on the obtained values of a and b, the surface tension γ_{S} of the photosensitive layer is calculated using the equation (E′). The calculated surface tension γ_{S} of the photosensitive layer corresponds to the surface free energy of the photosensitive layer. The above describes the method for measuring the surface free energy of the photosensitive layer.

### (Martens Hardness of the Photosensitive Layer)

To improve the wear resistance of the photoreceptor, the Martens hardness of the photosensitive layer (more specifically, the charge transport layer) is preferably 197 N/mm² or more, and more preferably 200 N/mm² or more. The upper limit of the Martens hardness of the photosensitive layer is not particularly limited, but the Martens hardness of the photosensitive layer is, for example, 300 N/mm² or less. The Martens hardness is measured by a method conforming to ISO 14577.

### (Additives)

Examples of the additives include, for example, a UV absorber, an antioxidant, a radical scavenger, a singlet quencher, a plasticizer, a surface modifier, a bulking agent, a thickener, a dispersion stabilizer, a wax, a donor, a surfactant, a plasticizer, a sensitizer, an electron acceptor compound, and a leveling agent. The leveling agent is preferably silicone oil, and more preferably silicone oil having a dimethylpolysiloxane structure.

### <Charge Generation Layer>

The charge generation layer 3a typically contains the charge generating agent. The charge generation layer 3a may contain a base resin, as necessary. The charge generation layer 3a may contain additives, as necessary. The thickness of the charge generation layer 3a is not particularly limited, but is preferably 0.01 μm or more and 5 μm or less, and more preferably 0.1 μm or more and 3 μm or less.

### (Charge Generating Agent)

Examples of the charge generating agent include a phthalocyanine-based pigment, a perylene-based pigment, a bisazo pigment, a trisazo pigment, a dithioketopyrrolopyrrole pigment, a metal-free naphthocyanine pigment, a metal naphthocyanine pigment, a squaraline pigment, an indigo pigment, an azulenium pigment, a cyanine pigment, a powder of an inorganic photoconductive material (e.g., selenium, selenium-tellurium, selenium-arsenic, cadmium sulfide, and amorphous silicon), a pyrylium pigment, an anthraquinone-based pigment, a triphenylmethane-based pigment, a Vat-based pigment, a toluidine-based pigment, a pyrazoline-based pigment, and a quinacridone-based pigment. The photosensitive layer may contain only one type of the charge generating agent or may contain two or more types of the charge generating agents.

The phthalocyanine-based pigment is a pigment having a phthalocyanine structure. Examples of the phthalocyanine-based pigment include, for example, a metal-free phthalocyanine and a metal phthalocyanine. Examples of the metal phthalocyanine include, for example, titanyl phthalocyanine, hydroxygallium phthalocyanine, and chlorogallium phthalocyanine. Titanyl phthalocyanine is represented by formula (CG-1). The metal-free phthalocyanine is represented by formula (CG-2).

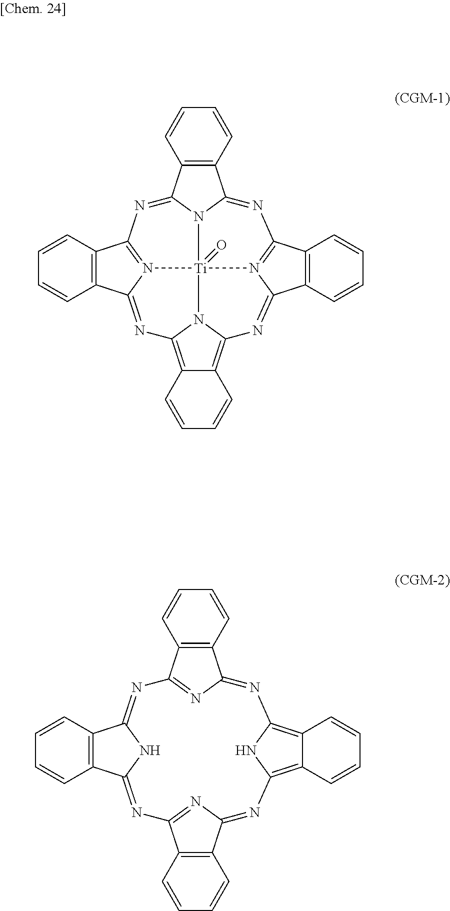

The phthalocyanine-based pigment may be crystalline or non-crystalline. Examples of the crystalline metal-free phthalocyanines include X-type crystal of the metal-free phthalocyanine (hereinafter sometimes referred to as X-type metal-free phthalocyanine). Examples of the crystalline titanyl phthalocyanine include α-type, β-type, and Y-type crystals of titanyl phthalocyanine (hereinafter referred to as α-type, β-type, and Y-type titanyl phthalocyanines, respectively).

For example, in a digital optical image forming apparatus (e.g., a laser beam printer or a facsimile using a light source such as a semiconductor laser), it is preferable to use the photoreceptor having sensitivity in the wavelength region of 700 nm or longer. Since it exhibits high quantum yields in the wavelength region of 700 nm or more, the phthalocyanine-based pigment is preferred as the charge generating agent, with the metal-free phthalocyanine or titanyl phthalocyanine being more preferred, titanyl phthalocyanine being even more preferred, and Y-type titanyl phthalocyanine being particularly preferred.

The Y-type titanyl phthalocyanine exhibits a main peak at, for example, a Bragg angle (2θ±0.2°) of 27.2° in the CuKα characteristic X-ray diffraction spectrum. The main peak in the CuKα characteristic X-ray diffraction spectrum is a peak with the first or second largest intensity in the range where the Bragg angle (2θ±0.2°) is 3° or more and 400 or less. The Y-type titanyl phthalocyanine does not have a peak at 26.2 °C in the CuKα characteristic X-ray diffraction spectrum.

The CuKα characteristic X-ray diffraction spectrum can be measured, for example, by the following method. First, a sample (titanyl phthalocyanine) is filled into a sample holder of an X-ray diffractometer (e.g., “RINT (registered trademark) 1100” manufactured by Rigaku Corporation). The X-ray diffraction spectrum is measured under the following conditions: X-ray tube of Cu, tube voltage of 40 kV, tube current of 30 mA, and a CuKα characteristic X-ray wavelength of 1.542 angstrom. The measurement range (2θ) is, for example, 3° or more and 40° or less (start angle 3°, stop angle 40°), and the scanning speed is, for example, 10°/min. The main peak is determined from the obtained X-ray diffraction spectrum, and the Bragg angle of the main peak is read.

A content of the charge generating agent is preferably 10 mass parts or more and 300 mass parts or less, and more preferably 100 mass parts or more and 230 mass parts or less per 100 mass parts of the base resin.

### (Additives)

The additives can be the same as those used in the charge transport layer 3b above. Examples include the UV absorber, the antioxidant, the radical scavenger, the singlet quencher, the plasticizer, the surface modifier, the bulking agent, the thickener, the dispersion stabilizer, the wax, the donor, the surfactant, the plasticizer, the sensitizer, the electron acceptor compound, and the leveling agent. The leveling agent is preferably the silicone oil, and more preferably the silicone oil having the dimethylpolysiloxane structure.

### (Base Resin)

Examples of the base resin include a thermoplastic resin (more specifically, a polyarylate resin, a polycarbonate resin, a styrene-based resin, a styrene-butadiene copolymer, a styrene-acrylonitrile copolymer, a styrene-maleic acid copolymer, a styrene-acrylic acid copolymer, an acrylic copolymer, a polyethylene resin, an ethylene-vinyl acetate copolymer, a chlorinated polyethylene resin, a polyvinyl chloride resin, a polypropylene resin, an ionomer, a vinyl chloride-vinyl acetate copolymer, a polyester resin, an alkyd resin, a polyamide resin, a polyurethane resin, a polysulfone resin, a diallyl phthalate resin, a ketone resin, a polyvinyl butyral resin, a polyvinyl acetal resin, and a polyether resin), a thermosetting resin (more specifically, a silicone resin, an epoxy resin, a phenol resin, a urea resin, a melamine resin, and other crosslinkable thermosetting resins), and a light-curable resin (more specifically, an epoxy-acrylic acid resin, and a urethane-acrylic acid copolymer). In order to form the charge generation layer and the charge transport layer effectively, it is preferable that the base resin be different from the first resin and the second resin.

### <Conductive Base>

The conductive base is not particularly limited and may be configured of a material having conductivity at least on its surface. An example of the conductive base is a conductive base configured of a conductive material. Another example of the conductive base is a conductive base coated with a conductive material. Examples of the conductive materials include aluminum, iron, copper, tin, platinum, silver, vanadium, molybdenum, chromium, cadmium, titanium, nickel, palladium, indium, stainless steel, and brass. Among these conductive materials, aluminum and an aluminum alloy are preferred because they facilitate good charge transfer from the photosensitive layer to the conductive base.

### <Intermediate Layer>

The intermediate layer (undercoat layer) contains, for example, inorganic particles and a resin used for the intermediate layer (intermediate layer resin). The presence of the intermediate layer maintains an insulating state sufficient to suppress leakage while facilitating a flow of current generated when the photoreceptor is exposed, thereby suppressing an increase in resistance.

Examples of the inorganic particles include particles of metals (e.g., aluminum, iron, and copper), particles of metal oxides (e.g., titanium oxide, alumina, zirconium oxide, tin oxide, and zinc oxide), and particles of non-metal oxides (e.g., silica).

Examples of the intermediate layer resin are the same as the examples of the other binder resins already described. To form the intermediate layer and photosensitive layer effectively, it is preferable that the intermediate layer resin be different from the binder resin contained in the photosensitive layer. The intermediate layer may contain additives. Examples of the additives contained in the intermediate layer are the same as the examples of additives contained in the photosensitive layer.

The shape of the conductive base is selected appropriately according to the structure of the image forming apparatus. Examples of the shape of the conductive base include sheet-shaped and drum-shaped. Furthermore, the thickness of the conductive base is selected appropriately according to the shape of the conductive base.

### <Method for Manufacturing Photoreceptor>

As a method for manufacturing a photoreceptor, an example of a method for manufacturing a laminated photoreceptor is described.

The method for manufacturing the laminated photoreceptor includes, for example, a charge generation layer formation step and a charge transport layer formation step. In the charge generation layer formation step, a coating solution for forming the charge generation layer (hereinafter sometimes referred to as a charge generation layer coating solution) is first prepared. The charge generation layer coating solution is applied onto the conductive base. Next, at least a portion of the solvent contained in the applied charge generation layer coating solution is removed to form the charge generation layer. The charge generation layer coating solution contains, for example, the charge generating agent, the base resin, and the solvent. Such a charge generation layer coating solution is prepared by dissolving or dispersing the charge generating agent and the base resin in the solvent. The charge generation layer coating solution may further contain the additives, as necessary.

In the charge transport layer formation step, the coating solution for forming the charge transport layer (hereinafter sometimes referred to as the charge transport layer coating solution) is first prepared. The charge transport layer coating solution is coated onto the charge generation layer. Next, at least a portion of the solvent contained in the coated charge transport layer coating solution is removed to form the charge transport layer. The charge transport layer coating solution contains the hole transport agent, the first resin, the second resin, and the solvent. The charge transport layer coating solution can be prepared by dissolving or dispersing the hole transport agent, the first resin, and the second resin in the solvent. The charge transport layer coating solution may contain the phthalocyanine pigment or the additives, as necessary.

The solvent contained in the charge generation layer coating solution and the charge transport layer coating solution (hereinafter sometimes collectively referred to as the coating solution) is not particularly limited, provided it can dissolve or disperse each component contained in the coating solution. Examples of the solvent include alcohols (more specifically, methanol, ethanol, isopropanol, and butanol, etc.), aliphatic hydrocarbons (more specifically, n-hexane, octane, and cyclohexane, etc.), aromatic hydrocarbons (more specifically, benzene, toluene, and xylene, etc.), halogenated hydrocarbons (more specifically, dichloromethane, dichloroethane, carbon tetrachloride, and chlorobenzene, etc.), ethers (more specifically, dimethyl ether, diethyl ether, tetrahydrofuran, ethylene glycol dimethyl ether, and diethylene glycol dimethyl ether, etc.), ketones (more specifically, acetone, methyl ethyl ketone, and cyclohexanone, etc.), esters (more specifically, ethyl acetate and methyl acetate, etc.), dimethylformaldehyde, dimethylformamide, and dimethyl sulfoxide.

The solvent contained in the charge transport layer coating solution is preferably different from the solvent contained in the charge generation layer coating solution. This is because, when applying the charge transport layer coating solution onto the charge generation layer, it is preferable that the charge generation layer do not dissolve in the solvent of the charge transport layer coating solution.

The coating solutions are prepared by mixing the respective components and dispersing them in the solvents. For mixing or dispersion, a bead mill, a roll mill, a ball mill, an attritor, a paint shaker, or an ultrasonic disperser can be used.

The method for applying the coating solution is not particularly limited, provided it can apply uniformly the coating solution. Examples of the coating method include a dip coating method, spray coating method, a spin coating method, and a bar coating method.

As the method for removing at least a portion of the solvent contained in the coating solution, examples include heating, vacuum reduction, or a combination of heating and vacuum reduction. More specifically, the method includes a thermal treatment (hot air drying) using a high-temperature dryer or a vacuum dryer. The temperature of the thermal treatment is, for example, 40 °C or more and 150 °C or less. The time of the thermal treatment is, for example, 3 minutes or more and 120 minutes or less.

In addition, the method for manufacturing the photoreceptor may further include one or both of an intermediate layer forming step and a protective layer forming step as necessary. The intermediate layer forming step and the protective layer forming step may be appropriately selected from known methods.

### Second Embodiment: Image Forming Apparatus

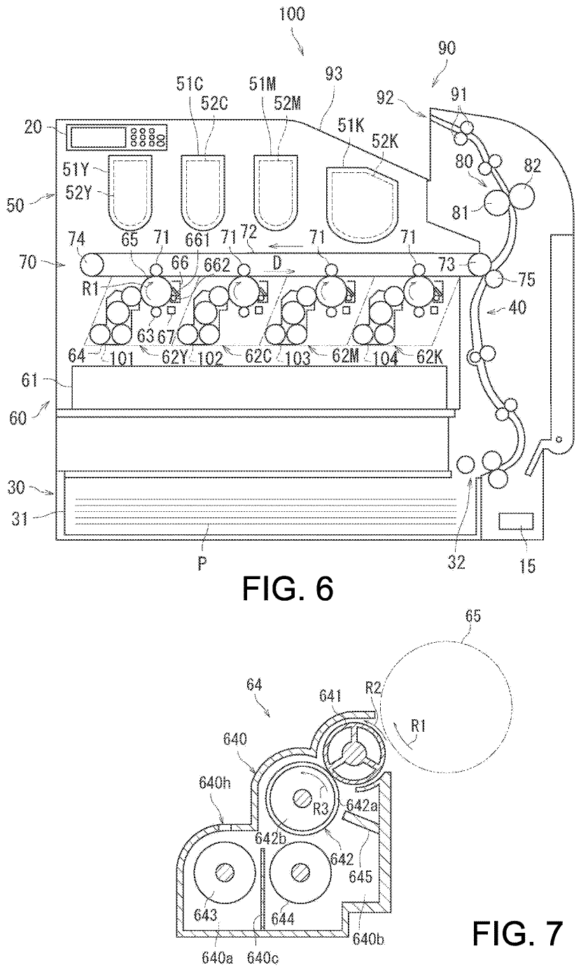

Next, referring to FIG. 6, an example of an image forming apparatus 100 according to a second embodiment of the present disclosure will be described. FIG. 6 is an example of a configuration of the image forming apparatus 100. The image forming apparatus 100 is, for example, a tandem-type color printer.

As shown in FIG. 6, the image forming apparatus 100 includes a control unit 15, an operation unit 20, a paper feed unit 30, a transport unit 40, a toner supply unit 50, an image forming unit 60, a transfer unit 70, a fixing unit 80, and an ejection unit 90.

The control unit 15 controls the operation of each unit provided in the image forming apparatus 100. The control unit 15 includes a processor (not shown) and a memory unit (not shown). The processor includes, for example, a CPU (Central Processing Unit). The memory unit includes a memory such as a semiconductor memory and may also include an HDD (Hard Disk Drive). The processor controls the operation of the image forming apparatus 100 by executing a control program. The memory unit stores the control program.

The operation unit 20 receives an instruction from a user. When the operation unit 20 receives the instruction from the user, it transmits a signal indicating the instruction from the user to the control unit 15. As a result, an image forming operation by the image forming apparatus 100 is initiated.

The paper feed unit 30 includes a paper feed cassette 31 and a paper feed roller group 32. The paper feed cassette 31 can accommodate a plurality of recording media P (e.g., paper). The paper feed roller group 32 feeds the recording media P accommodated in the paper feed cassette 31 one sheet at a time to the transport unit 40.

The transport unit 40 includes rollers and guide members. The transport unit 40 extends from the paper feed unit 30 to the discharge unit 90. The transport unit 40 transports the recording media P from the paper feed unit 30 to the discharge unit 90, passing through the image forming unit 60 and the fixing unit 80.

The toner supply unit 50 supplies toner to the image forming unit 60. The toner supply unit 50 includes a first mounting unit 51Y, a second mounting unit 51C, a third mounting unit 51M, and a fourth mounting unit 51K.

A first toner container 52Y is mounted on the first mounting unit 51Y. Similarly, a second toner container 52C is mounted on the second mounting unit 51C, a third toner container 52M is mounted on the third mounting unit 51M, and a fourth toner container 52K is mounted on the fourth mounting unit 51K.

The first toner container 52Y, the second toner container 52C, the third toner container 52M, and the fourth toner container 52K each contain the toner. In the second embodiment, the first toner container 52Y contains yellow toner. The second toner container 52C contains cyan toner. The third toner container 52M contains magenta toner. The fourth toner container 52K contains black toner.

The image forming unit 60 includes an exposure device 61, a first image forming unit 62Y, a second image forming unit 62C, a third image forming unit 62M, and a fourth image forming unit 62K.

Each of the first image forming unit 62Y to the fourth image forming unit 62K has a charging device 63, a developing device 64, an image carrier 65, a cleaning device 66, and an electricity removal device 67.

Note that the configurations of the first image forming unit 62Y to the fourth image forming unit 62K differ only in the type of the toner supplied from the toner supply unit 50; the other configurations are identical. Therefore, in FIG. 6, each configuration of the second image forming unit 62C to the fourth image forming unit 62K is shown with each reference numeral omitted.

The image carrier 65 is the photoreceptor 1 in the first embodiment. As described above, the photoreceptor 1 in the first embodiment can achieve both the excellent anti-filming properties and wear resistance. Therefore, the image forming apparatus 100 in the second embodiment can achieve both the excellent anti-filming properties and wear resistance.

In the second embodiment, the image carrier 65 rotates in the direction indicated by an arrow R1 in FIG. 6 (clockwise in FIG. 6). The charging device 63, the developing device 64, the cleaning device 66, and the electricity removal device 67 are arranged along a peripheral surface of the image carrier 65 in the order listed from an upstream side relative to the rotation direction of the image carrier 65.

The charging device 63 charges the surface (peripheral surface) of the image carrier 65. The charging device 63 uniformly charges the image carrier 65 to a predetermined polarity by discharge. The charging device 63 is, for example, a charging roller.

The exposure device 61 exposes the surface of the charged image carrier 65. Specifically, the exposure device 61 irradiates the surface of the charged image carrier 65 with laser light. This forms an electrostatic latent image on the surface of the image carrier 65.

The toner is supplied to the developing device 64 from the toner supply unit 50. The developing device 64 supplies the toner supplied from the toner supply unit 50 onto the surface of the image carrier 65. As a result, the electrostatic latent image formed on the surface of the image carrier 65 is developed as a toner image.

In the second embodiment, the developing device 64 of the first image forming unit 62Y is connected to the first toner container 52Y. Therefore, the yellow toner is supplied to the developing device 64 of the first image forming unit 62Y. Consequently, a yellow toner image is formed on the surface of the image carrier 65 of the first image forming unit 62Y.

Similarly, the developing device 64 of the second image forming unit 62C, the developing device 64 of the third image forming unit 62M, and the developing device 64 of the fourth image forming unit 62K are each connected to the second toner container 52C, the third toner container 52M, and the fourth toner container 52K, respectively. Therefore, the cyan toner, the magenta toner, and the black toner are supplied to the developing device 64 of the second image forming unit 62C, the developing device 64 of the third image forming unit 62M, and the developing device 64 of the fourth image forming unit 62K, respectively. Thus, a cyan toner image, a magenta toner image, and a black toner image are formed on the surface of the image carriers 65 of the second image forming unit 62C, the surface of the image carriers 65 of the third image forming unit 62M, and the surface of the image carriers 65 of the fourth image forming unit 62K, respectively.

The cleaning device 66 includes a cleaning member 661 and a friction roller 662. After transfer by a primary transfer roller 71 described later, the cleaning member 661 is pressed against the surface of the image carrier 65 to recover the toner adhering to the surface of the image carrier 65. The cleaning member 661 is, for example, a cleaning blade. The friction roller 662 rubs against the surface of the image carrier 65 to polish the surface of the image carrier 65.

The electricity removal device 67 removes electricity on the surface of the image carrier 65 by irradiating the surface of the image carrier 65 with electricity removal light.

The transfer device 70 transfers the toner image from the image carrier 65 to the recording medium P, which is a transfer target. Specifically, the transfer device 70 transfers each toner image formed on the surface of each image carrier 65 included in the first image forming unit 62Y to the fourth image forming unit 62K, onto the recording medium P in a superimposed manner. In the second embodiment, the transfer device 70 transfers each toner image onto the recording medium P in a secondary transfer method (intermediate transfer method). The transfer device 70 includes four primary transfer rollers 71, an intermediate transfer belt 72, a drive roller 73, a driven roller 74, and a secondary transfer roller 75.

The intermediate transfer belt 72 is an endless belt stretched over the four primary transfer rollers 71, the drive roller 73, and the driven roller 74. The intermediate transfer belt 72 is driven in response to the rotation of the drive roller 73. The intermediate transfer belt 72 rotates counterclockwise as shown in FIG. 6. The driven roller 74 is rotated in response to the drive of the intermediate transfer belt 72.

The first image forming unit 62Y to the fourth image forming unit 62K are arranged facing the underside of the intermediate transfer belt 72. In the second embodiment, the first image forming unit 62Y to the fourth image forming unit 62K are arranged in the order of the first image forming unit 62Y to the fourth image forming unit 62K from the upstream side to the downstream side of the driving direction D of the underside of the intermediate transfer belt 72.

Each primary transfer roller 71 is arranged facing each image carrier 65 via the intermediate transfer belt 72 and presses against each image carrier 65. Consequently, the toner image formed on the surface of each image carrier 65 is sequentially transferred to the intermediate transfer belt 72 by each primary transfer roller 71. In the second embodiment, the yellow toner image, the cyan toner image, the magenta toner image, and the black toner image are transferred onto the intermediate transfer belt 72 in that order. Hereinafter, the toner image formed by superimposing the yellow toner image, the cyan toner image, the magenta toner image, and the black toner image may be referred to as “a laminated toner image.”

The secondary transfer roller 75 is arranged facing the drive roller 73 via the intermediate transfer belt 72. The secondary transfer roller 75 is pressed against the drive roller 73. This creates a transfer nip between the secondary transfer roller 75 and the drive roller 73. As the recording medium P passes through the transfer nip, the laminated toner image on the intermediate transfer belt 72 is transferred onto the recording medium P by the secondary transfer roller 75. In the second embodiment, the yellow toner image, the cyan toner image, the magenta toner image, and the black toner image are transferred to the recording medium P in this order, from the top layer to the bottom layer. The recording medium P with the laminated toner image transferred is transported by the transport unit 40 toward the fixing device 80.

The fixing unit 80 includes a heating member 81 and a pressing member 82. The heating member 81 and the pressing member 82 are arranged facing each other, forming a fixing nip. The recording medium P transported from the image forming unit 60 is heated to a predetermined fixing temperature and pressed as it passes through the fixing nip. As a result, the laminated toner image is fixed to the recording medium P. The recording medium P is transported from the fixing unit 80 to the discharge unit 90 by the transport unit 40.

The discharge unit 90 includes a pair of discharge rollers 91 and a discharge tray 93. The pair of the discharge rollers 91 transports the recording medium P to the discharge tray 93 via a discharge outlet 92. The discharge outlet 92 is formed at the top of the image forming apparatus 100.

Next, referring to FIG. 7, the configuration of the developing device 64 will be described in detail. FIG. 7 is a diagram showing an example of the configuration of the developing device 64. Specifically, FIG. 7 shows the developing device 64 included in the first image forming unit 62Y. Note that in FIG. 7, the image carrier 65 is shown with a two-dot dashed line for ease of understanding. In the second embodiment, the developing device 64 employs a two-component developing method using a two-component developer and employs a touchdown developing method.

As already described with reference to FIG. 6, the developing container 640 of the developing device 64 is connected to the first toner container 52Y. Therefore, the yellow toner is supplied to the developing container 640 of the developing device 64 via a toner supply port 640h.

As shown in FIG. 7, the developing device 64 has a developing roller 641, a magnetic roller 642, a first stirring screw 643, a second stirring screw 644, and a blade 645 inside the developing container 640. Specifically, the developing roller 641 is arranged facing the magnetic roller 642. The magnetic roller 642 is arranged facing the second stirring screw 644. The blade 645 is arranged facing the magnetic roller 642.

The developing container 640 is partitioned into a first stirring chamber 640a and a second stirring chamber 640b by a partition wall 640c. The partition wall 640c extends in the axial direction of the developing roller 641. The first stirring chamber 640a and the second stirring chamber 640b are connected at the outer ends of the longitudinal direction of the partition wall 640c.

A first stirring screw 643 is arranged in the first stirring chamber 640a. A magnetic carrier is contained within the first stirring chamber 640a. Non-magnetic toner is supplied to the first stirring chamber 640a through the toner supply port 640h. In the example shown in FIG. 7, the yellow toner is supplied to the first stirring chamber 640a.

A second stirring screw 644 is arranged in the second stirring chamber 640b. The magnetic carrier is contained within the second stirring chamber 640b.

The yellow toner is stirred with the carrier by the first stirring screw 643 and the second stirring screw 644. As a result, a two-component developer containing the carrier and the yellow toner is formed. The two-component developer is then contained within the developing container 640 (more specifically, the first stirring chamber 640a and the second stirring chamber 640b).

The first stirring screw 643 and the second stirring screw 644 circulate and stir the two-component developer between the first stirring chamber 640a and the second stirring chamber 640b. As a result, the toner becomes charged with a predetermined polarity due to friction with the carrier.

Note that the image carrier 65 is the laminated photoreceptor 1, and the surface of the image carrier 65 and the toner are charged to a negative polarity, for example.

The magnetic roller 642 is configured of a non-magnetic rotating sleeve 642a and a magnet body 642b. The magnet body 642b is fixedly arranged inside the rotating sleeve 642a. The magnet body 642b contains a plurality of magnetic poles. The two-component developer is attracted to the magnetic roller 642 by a magnetic force of the magnet body 642b. As a result, a magnetic brush is formed on the surface of magnetic roller 642.

The blade 645 is arranged upstream of the rotational direction of the magnetic roller 642, relative to the position where the magnetic roller 642 and the developing roller 641 face each other. In the second embodiment, the magnetic roller 642 rotates in the direction indicated by an arrow R3 in FIG. 7 (counterclockwise in FIG. 7). The magnetic roller 642 transports the magnetic brush to the position facing the blade 645 by rotating. The blade 645 is arranged such that a gap is formed between it and the magnetic roller 642. The blade 645 is configured of a magnetic material. Therefore, the thickness of the magnetic brush is regulated by the magnetic force of the blade 645.

After the thickness of the magnetic brush on the magnetic roller 642 is regulated, a predetermined voltage is applied to the magnetic roller 642 and the developing roller 641. When the predetermined voltage is applied, creating a predetermined potential difference between the magnetic roller 642 and the developing roller 641, the yellow toner contained in the two-component developer migrates to the developing roller 641. As a result, a toner thin layer configured of the yellow toner is formed on the surface of the developing roller 641.

The developing roller 641 rotates in the direction indicated by an arrow R2 in FIG. 7 (counterclockwise in FIG. 7). This transports the toner thin layer formed on the surface to a position facing the image carrier 65, where it adheres to the image carrier 65. In this manner, the developing device 64 supplies the toner, charged by friction with the carrier, to the surface of the image carrier 65.

The above describes the developing device 64 of the first image forming unit 62Y with reference to FIG. 7. The configuration of the developing device 64 in each of the first image forming unit 62Y to the fourth image forming unit 62K is identical except for the type of the toner supplied from the toner supply unit 50. Therefore, the description of the configuration of the developing device 64 in the second image forming unit 62C to the fourth image forming unit 62K is omitted.

Thus far, with reference to FIGS. 6 and 7, an example of the image forming apparatus 100, which is the image forming apparatus in the second embodiment, has been described. However, the image forming apparatus in the second embodiment is not limited to the image forming apparatus 100. For example, the image forming apparatus may be a monochrome image forming apparatus. In this case, the image forming apparatus may include only one image forming unit. The image forming apparatus may employ a rotary method. The charging device may be a charging device other than the charging roller (e.g., a scototron charger, a charging brush, or a colotron charger). The image forming apparatus may employ a single-component developing method using a single-component developer. The image forming apparatus may employ a developing method other than the touchdown developing method (e.g., a developing method that does not include the developing roller, where the magnetic roller also functions as the developing roller). The image forming apparatus may employ a direct transfer method. When the image forming apparatus employs the direct transfer method, the toner image is directly transferred from the image carrier to the recording medium while the image carrier is in contact with the recording medium. The image forming apparatus may not include the cleaning device. The image forming apparatus may not include the electricity removal device. The above describes the image forming apparatus in the second embodiment.

### Third Embodiment: Process Cartridge

Next, with continued reference to FIG. 6, the process cartridge in the third embodiment of the present disclosure will be described. The process cartridge in the third embodiment corresponds to each of the first image forming unit 62Y to the fourth image forming unit 62K. The process cartridge includes the image carrier 65, and the image carrier 65 is the photoreceptor 1 in the first embodiment. As described in the first embodiment, the photoreceptor in the first embodiment can achieve both the excellent anti-filming properties and wear resistance. Therefore, the process cartridge in the third embodiment can achieve both the excellent anti-filming properties and wear resistance.

The process cartridge may further include, in addition to the image carrier 65, at least one (e.g., one to seven) selected from the group consisting of the charging device 63, the exposure device 61, the developing device 64, the transfer device 70 (specifically, the primary transfer roller 71), the cleaning member 661, the friction roller 662, and the electricity removal device 67. The process cartridge is designed to be freely attached/detached from the image forming apparatus 100. Therefore, the process cartridge is easy to handle, and when the sensitivity characteristics of the image carrier 65 deteriorate, the image carrier 65 can be easily and quickly replaced. The above describes the process cartridge in the third embodiment with reference to FIG. 6.

### EXAMPLE

Hereinafter, the present disclosure will now be described in more detail using examples. However, the present disclosure is not limited to the scope of the examples.

### <Materials for Forming the Charge Transport Layer>

The first resin, the second resin, the hole transport agent, and the phthalocyanine pigment were prepared below as the materials for forming the charge transport layer of the photoreceptor.

### (First Resin)

As the first resin used in the manufacture of the laminated photoreceptor, the first resins (A-1) to (A-6) (hereinafter also referred to as siloxane-containing PC resins (A-1) to (A-6)) used in Examples 1-1 to 1-15 and Comparative Examples 1-1 to 1-7 were prepared.

The siloxane-containing PC resins (A-1), (A-4), (A-5), and (A-6) each includes the repeating unit (a1), the repeating unit (PC-1-1), the repeating unit (PC-2-2), and the terminal group (PC-T) described in the embodiments. The siloxane-containing PC resins (A-1), (A-4), (A-5), and (A-6) have different viscosity average molecular weights, respectively.

The siloxane-containing PC resin (A-2) includes the repeating unit (a1), the repeating unit (PA-1-1), the repeating unit (PA-2-1), the repeating unit (PA-3), and the repeating unit (PA-4) described in the embodiments.

The siloxane-containing PC resin (A-3) includes the repeating unit (a1), the repeating unit (PA-1-1), the repeating unit (PA-2-2), and the repeating unit (PA-4) described in the embodiments.

The viscosity average molecular weights of the siloxane-containing PC resins (A-1) to (A-6) were measured according to JIS K7252-1:2016. The results are shown in Tables 2A-2B.

Furthermore, for the siloxane-containing PC resins (A-1) to (A-6), when their total amount was set to 100 mol %, those having a content ratio of the repeating unit represented by formula (a1) (the repeating unit having the siloxane structure) within the range of 0.5 mol % or more and 20 mol % or less were used.

As the first resin used in the manufacture of the laminated photoreceptor, the first resins (C-1) to (C-5) below (hereinafter also referred to as the siloxane-containing PC resins (C-1) to (C-5)) used in Examples 2-1 to 2-19 and Comparative Examples 2-1 to 2-7 were prepared.

The siloxane-containing PC resins (C-1) to (C-5) include the repeating unit (a1), the repeating unit (PC-1-1), the repeating unit (PC-2-2), and the terminal group (PC-T) described in the embodiments. The siloxane-containing PC resins (C-1) to (C-5) have different viscosity average molecular weights. The viscosity average molecular weights were measured according to JIS K7252-1:2016. The results are shown in Tables 3A-3C.

Furthermore, for the siloxane-containing PC resins (C-1) to (C-5), when the total amount was set to 100 mol %, those having the content ratio of the repeating unit represented by formula (a1) (a repeating unit having the siloxane structure) within the range of 0.5 mol % or more and 20 mol % or less were used.

### (Second Resin)

As the second resin used in the manufacture of the laminated photoreceptor, the polycarbonate resin (B-1) and polyarylate resins (B-2) to (B-3) (hereinafter simply referred to as the PC resin (B-1), and the PA resins (B-2), (B-3) hereafter) were prepared below.

The PC resin (B-1) is a polycarbonate resin that does not include the siloxane structure in its main chain and has the repeating units represented by the repeating units (PC-1-1) and (PC-2-1) described in the embodiments.

The PA resin (B-2) is a polyarylate resin that does not include the siloxane structure and has the repeating units represented by (PA-1-1), (PA-2-1), (PA-3), and (PA-4) as described in the embodiment.

The PA resin (B-3) is a polyarylate resin that does not include the siloxane structure and has the repeating units represented by the repeating units (PA-1-1), (PA-2-2), and (PA-4) described in the embodiments.

The polycarbonate resin (D-1) (hereinafter simply referred to as a PC resin (D-1)), used in Examples 2-1 to 2-19 and Comparative Examples 2-1 to 2-7, was prepared below.

The PC resin (D-1) is similar to the PC resin (B-1), does not include the siloxane structure, and is the polycarbonate resin having repeating units represented by the repeating units (PC-1-1) and (PC-2-1) described in the embodiments.

### (Hole Transport Agent)

As the hole transport agent, each of the compounds (H-1) to (H-7) described in the embodiments was used.

### (Phthalocyanine Pigment)

As the phthalocyanine pigment, each of the phthalocyanine pigments (K-1) to (K-2) described in the embodiments and the following pigments represented by formulae (K-3) to (K-4) (hereinafter also simply referred to as a pigment (K-3) and a pigment (K-4)), other than the specified phthalocyanine pigments, were used.

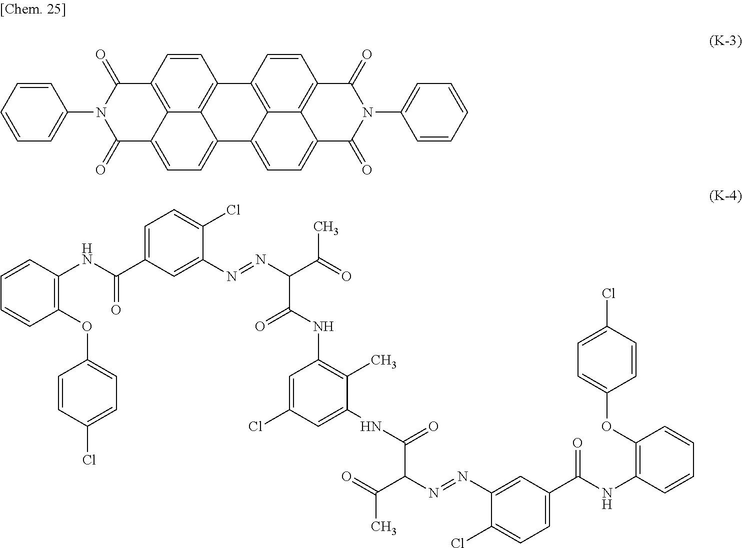

### <Preparation of Photoreceptors According to Examples 1-1 to 1-15 and Comparative Examples 1-1 to 1-7>

The laminated photoreceptors according to Examples 1-1 to 1-15 and Comparative Examples 1-1 to 1-7, which contained the first resin, the second resin, and the hole transport agent of this embodiment, were prepared. Tables 2A-2B show the types and the contents (mass parts) of the first resin and the second resin used, and the type of the hole transport material (HTM) used, per 100 mass parts of the binder resin.

### Example 1-1

### (Preparation of a Laminated Photoreceptor for Evaluation)

2 parts by mass of titanium oxide surface-treated with alumina and silica, then surface-treated with methyl hydrogen polysiloxane while wet-dispersing (SMT-A manufactured by Taica Corporation, number-average primary particle size 10 nm), 1 part by mass of a quaternary copolymer polyamide resin (Amilan CM8000 manufactured by Toray Industries, Inc.), 10 parts by mass of methanol, 1 part by mass of butanol, and 1 part by mass of toluene were dispersed in a bead mill for 5 hours to prepare a coating solution for an undercoat layer.

The obtained coating solution for the undercoat layer was filtered through a 5-micron filter. A 30-mm diameter aluminum drum-shaped support was used as a conductive support, was coated using the dip coating method, and heat-treated at 130 °C for 30 minutes, forming the undercoat layer with a film thickness of 1.5 μm.

Next, 2.3 parts by mass of Y-type titanyl phthalocyanine, 1 part by mass of polyvinyl acetate resin (S-LEC BX-5, manufactured by Sekisui Chemical Co., Ltd.) as the binder resin, 40 parts by mass of propylene glycol monomethyl ether, and 40 parts by mass of tetrahydrofuran as a dispersion medium were mixed. This mixture was dispersed in a bead mill for 12 hours to prepare the charge generation layer coating solution. The resulting coating solution was filtered through a 3-micron filter, then applied onto the undercoat layer prepared as above by the dip coating method, and dried at 50 °C for 5 minutes to form the charge generation layer with a film thickness of 0.3 μm.

Next, 45 parts by mass of the hole transport material (HTM) represented by the formula (H-1), 5 parts by mass of the siloxane-containing polycarbonate resin (A-1) as a binder resin, 95 parts by mass of the polycarbonate resin (B-1), 0.05 parts by mass of dimethyl silicone oil KF96-50CS as the leveling agent, and 560 parts by mass of tetrahydrofuran and 140 parts by mass of toluene as the solvents were mixed to prepare the charge transport layer coating solution.

The prepared charge transport layer coating solution was applied onto the charge generation layer in the same manner as the charge generation layer coating solution, dried at 120 °C for 40 minutes to form the charge transport layer with a film thickness of 25 μm, thereby preparing the laminated electrophotographic photoreceptor.

### Example 1-2

In Example 1-1, the laminated electrophotographic photoreceptor was prepared in exactly the same manner except for changing the binder resin in the charge transport layer coating solution to 15 parts by weight of the siloxane-containing PC resin (A-1) and 85 parts by weight of the polyarylate resin (B-1).

### Example 1-3

In Example 1-1, the laminated electrophotographic photoreceptor was prepared in exactly the same manner except for changing the binder resin in the charge transport layer coating solution to 25 parts by weight of the siloxane-containing polycarbonate resin (A-1) and 75 parts by weight of the polycarbonate resin (B-1).

### Example 1-4

In Example 1-1, the laminated electrophotographic photoreceptor was prepared in exactly the same manner except for changing the siloxane-containing PC resin (A-1) in the charge transport layer coating solution to the siloxane-containing resin (A-2).

### Example 1-5

In Example 1-1, the laminated electrophotographic photoreceptor was prepared in exactly the same manner except for changing the siloxane-containing PC resin (A-1) in the charge transport layer coating solution to the siloxane-containing PC resin (A-3).

### Example 1-6

In Example 1-6, the laminated electrophotographic photoreceptor was prepared in exactly the same manner except for changing the PC resin (B-1) in the second resin in the charge transport layer coating solution to the PA resin (B-2).

### Example 1-7

In Example 1-6, the laminated electrophotographic photoreceptor was prepared in exactly the same manner except for changing the PC resin (B-1) in the second resin in the charge transport layer coating solution to the PA resin (B-3).

### Example 1-8

In Example 1-2, the laminated electrophotographic photoreceptor was prepared in exactly the same manner except for changing the first resin in the charge transport layer coating solution to the siloxane-containing PC resin (A-4) having the viscosity average molecular weight of 10,000.

### Example 1-9

In Example 1-2, the laminated electrophotographic photoreceptor was prepared in exactly the same manner except for changing the first resin in the charge transport layer coating solution to the siloxane-containing polycarbonate resin (A-5) having the viscosity average molecular weight of 25,000.

### Example 1-10

In Example 1-2, the laminated electrophotographic photoreceptor was prepared in exactly the same manner except for changing the hole transport agent in the charge transport layer coating solution from (H-1) to (H-2).

### Example 1-11

In Example 1-2, the laminated electrophotographic photoreceptor was prepared in exactly the same manner except for changing the hole transport agent in the charge transport layer coating solution was changed from (H-1) to (H-3).

### Example 1-12

In Example 1-2, the laminated electrophotographic photoreceptor was prepared in exactly the same manner except for changing the hole transport agent in the charge transport layer coating solution from (H-1) to (H-4).

### Example 1-13

In Example 1-2, the laminated electrophotographic photoreceptor was prepared in exactly the same manner except for changing the hole transport agent in the charge transport layer coating solution was changed from (H-1) to (H-5).

### Example 1-14

In Example 1-2, the laminated electrophotographic photoreceptor was prepared in exactly the same manner except for changing the hole transport agent in the charge transport layer coating solution from (H-1) to (H-6).

### Example 1-15

In Example 1-2A, the laminated electrophotographic photoreceptor was prepared in the exactly same manner except for changing the hole transport agent in the charge transport layer coating solution from (H-1) to (H-7).

### Comparative Example 1-1

In Example 1-1, the laminated electrophotographic photoreceptor was prepared in exactly the same manner except for changing the binder resin to 100 parts by weight of the siloxane-containing polycarbonate resin (A-1) and for not containing the polycarbonate resin (B-1).

### Comparative Example 1-2

In Example 1-1, the laminated electrophotographic photoreceptor was prepared in exactly the same manner except for not containing the siloxane-containing polycarbonate resin (A-1) as the binder resin and changing to 100 parts by mass of the polycarbonate resin (B-1).

### Comparative Example 1-3

In Example 1-1, the laminated electrophotographic photoreceptor was prepared in exactly the same manner except for changing as the binder resin to 40 parts by weight of the siloxane-containing polycarbonate resin (A-1) and 60 parts by weight of the polycarbonate resin (B-1).

### Comparative Example 1-4

In Example 1-8, the laminated electrophotographic photoreceptor was prepared in exactly the same manner except for changing as the binder resin to 40 parts by weight of the siloxane-containing polycarbonate resin (A-4) and 60 parts by weight of the polycarbonate resin (B-1).

### Comparative Example 1-5

In Example 1-9, the laminated electrophotographic photoreceptor was prepared in exactly the same manner except for changing as the binder resin to 40 parts by weight of the siloxane-containing polycarbonate resin (A-5) and 60 parts by weight of the polycarbonate resin (B-1).

### Comparative Example 1-6

In Example 1-1, the laminated electrophotographic photoreceptor was prepared in exactly the same manner except for changing the first resin in the charge transport layer coating solution to the siloxane-containing polycarbonate resin (A-6) having a viscosity average molecular weight of 50,000.

### Comparative Example 1-7

In Example 1-3, the laminated electrophotographic photoreceptor was prepared in exactly the same manner except for changing the first resin in the charge transport layer coating solution to the siloxane-containing polycarbonate resin (A-6) having a viscosity average molecular weight of 50,000.

### <Preparation of Photoreceptors According to Examples 2-1 to 2-19 and Comparative Examples 2-1 to 2-7>

The photoreceptors according to Examples 2-1 to 2-19 and Comparative Examples 2-1 to 2-7, which contained the first resin, the second resin, the hole transport agent, and the phthalocyanine pigment according to this embodiment, were prepared. Tables 3A-3C show the types and contents (mass parts) of the first resin and the second resin used, the type of hole transport material (HTM), and the type and content (mass parts) of the pigment, per 100 mass parts of binder resin.

### Example 2-1

### (Preparation of Laminated Photoreceptor for Evaluation)

2 parts by mass of titanium oxide surface-treated with alumina and silica, then surface-treated with methyl hydrogen polysiloxane while wet-dispersing (SMT-A, manufactured by Taica Corporation, number-average primary particle size 10 nm), 1 part by mass of a quaternary copolymer polyamide resin (Amilan CM8000 manufactured by Toray Industries, Inc.), 10 parts by mass of methanol, 1 part by mass of butanol, and 1 part by mass of toluene were dispersed in a bead mill for 5 hours to prepare a coating solution for an undercoat layer.

The obtained coating solution for the undercoat layer was filtered through a 5-micron filter. A 30-mm diameter aluminum drum-shaped support was used as a conductive support, was coated using the dip coating method, and heat-treated at 130 °C for 30 minutes, forming the undercoat layer with a film thickness of 1.5 μm.

Next, 2.3 parts by mass of Y-type titanyl phthalocyanine, 1 part by mass of polyvinyl acetate resin (S-LEC BX-5, manufactured by Sekisui Chemical Co., Ltd.) as the binder resin, 40 parts by mass of propylene glycol monomethyl ether, and 40 parts by mass of tetrahydrofuran as a dispersion medium were mixed. This mixture was dispersed in a bead mill for 12 hours to prepare the charge generation layer coating solution. The resulting coating solution was filtered through a 3-micron filter, then applied onto the undercoat layer prepared as above by the dip coating method, and dried at 50 °C for 5 minutes to form a charge generation layer with a film thickness of 0.3 μm.

Next, 45 parts by mass of the compound represented by the formula (H-1) as the hole transport agent, 5 parts by mass of the siloxane-containing polycarbonate resin (C-1) as the binder resin, 95 parts by mass of the polyarylate resin (D-1), 0.1 parts by mass of Y-type titanyl phthalocyanine (K-1), 0.05 parts by mass of dimethyl silicone oil KF96-50CS as the leveling agent, and 560 parts by mass of tetrahydrofuran and 140 parts by mass of toluene as the solvents were mixed to prepare the charge transport layer coating solution.

The prepared charge transport layer coating solution was applied onto the charge generation layer in the same manner as the charge generation layer coating solution, dried at 120 °C for 40 minutes to form the charge transport layer with a film thickness of 25 μm, thereby preparing the laminated electrophotographic photoreceptor.

### Example 2-2

In Example 2-1, the laminated electrophotographic photoreceptor was prepared in exactly the same manner except for changing the amount of the Y-type titanylphthalocyanine (K-1) in the charge transport layer coating solution was changed from 0.1 parts by weight to 0.3 parts by weight.

### Example 2-3

In Example 2-1, the laminated electrophotographic photoreceptor was prepared in exactly the same manner except for changing the amount of the Y-type titanyl phthalocyanine (K-1) in the charge transport layer coating solution from 0.1 parts by weight to 0.7 parts by weight.

### Example 2-4

In Example 2-2, the laminated electrophotographic photoreceptor was prepared in exactly the same manner except for changing the binder resin in the charge transport layer coating solution to 15 parts by weight of the siloxane-containing polyarylate resin (C-1) and 85 parts by weight of the polycarbonate resin (D-1).

### Example 2-5

In Example 2-2, the laminated electrophotographic photoreceptor was prepared in exactly the same manner except for changing the binder resin in the charge transport layer coating solution to 25 parts by weight of the siloxane-containing polycarbonate resin (C-1) and 75 parts by weight of the polycarbonate resin (D-1).

### Example 2-6

In Example 2-4, the laminated electrophotographic photoreceptor was prepared in exactly the same manner except for changing the first resin in the charge transport layer coating solution to the siloxane-containing polycarbonate resin (C-4) having the viscosity average molecular weight of 10,000.

### Example 2-7

In Example 2-4, the laminated electrophotographic photoreceptor was prepared in exactly the same manner except for changing the first resin in the charge transport layer coating solution to the siloxane-containing polycarbonate resin (C-5) having the viscosity average molecular weight of 25,000.

### Example 2-8

In Example 2-4, the laminated electrophotographic photoreceptor was prepared in exactly the same manner except for changing the second resin in the charge transport layer coating solution from the polycarbonate resin (D-1) to the polyarylate resin (D-2).

### Example 2-9

In Example 2-4, the laminated electrophotographic photoreceptor was prepared in exactly the same manner except for changing the second resin in the charge transport layer coating solution from the polycarbonate resin (D-1) to the polyarylate resin (D-3).

### Example 2-10

In Example 2-4, the laminated electrophotographic photoreceptor was prepared in exactly the same manner except for changing the hole transport agent in the charge transport layer coating solution was changed from (H-1) to (H-2).

### Example 2-11

In Example 2-4, the laminated electrophotographic photoreceptor was prepared in exactly the same manner except for changing the hole transport agent in the charge transport layer coating solution from (H-1) to (H-3).

### Example 2-12

In Example 2-4, the laminated electrophotographic photoreceptor was prepared in exactly the same manner except for changing the hole transport agent in the charge transport layer coating solution from (H-1) to (H-4).

### Example 2-13

In Example 2-4, the laminated electrophotographic photoreceptor was prepared in exactly the same manner except for changing the hole transport agent in the charge transport layer coating solution from (H-1) to (H-5).

### Example 2-14

In Example 2-4, the laminated electrophotographic photoreceptor was prepared in exactly the same manner except for changing the hole transport agent in the charge transport layer coating solution from (H-1) to (H-6).

### Example 2-15

In Example 2-4, the laminated electrophotographic photoreceptor was prepared in exactly the same manner except for changing the hole transport agent in the charge transport layer coating solution from (H-1) to (H-7).

### Example 2-16

In Example 2-2, the laminated electrophotographic photoreceptor was prepared in exactly the same manner except for changing the phthalocyanine pigment in the charge transport layer coating solution from (K-1) to (K-2).

### Example 2-17

In Example 2-1, the laminated electrophotographic photoreceptor was prepared in exactly the same manner except for changing the amount of phthalocyanine pigment (K-1) in the charge transport layer coating solution from 0.1 parts by weight to 0.

### Example 2-18

In Example 2-2, the laminated electrophotographic photoreceptor was prepared in exactly the same manner except for changing the phthalocyanine pigment in the charge transport layer coating solution from (K-1) to (K-4).

### Example 2-19

In Example 2-2, the laminated electrophotographic photoreceptor was prepared in exactly the same manner except for changing the phthalocyanine pigment in the charge transport layer coating solution from (K-1) to (K-3).

### Comparative Example 2-1

In Example 2-17, the laminated electrophotographic photoreceptor was prepared in exactly the same manner except for changing the binder resin in the charge transport layer coating solution to 40 parts by weight of the siloxane-containing polycarbonate resin (C-1) and 60 parts by weight of the polyarylate resin (D-1).

### Comparative Example 2-2

In Example 2-2, the laminated electrophotographic photoreceptor was prepared in exactly the same manner except for changing the binder resin in the charge transport layer coating solution to 40 parts by weight of the siloxane-containing polycarbonate resin (C-1) and 60 parts by weight of the polycarbonate resin (D-1).

### Comparative Example 2-3

In Example 2-6, the laminated electrophotographic photoreceptor was prepared in exactly the same manner except for changing the binder resin in the charge transport layer coating solution to 40 parts by weight of the siloxane-containing polycarbonate resin (C-1) and 60 parts by weight of the polycarbonate resin (D-1).

### Comparative Example 2-4

In Example 2-2, the laminated electrophotographic photoreceptor was prepared in exactly the same manner except for changing the binder resin to 0 parts by weight of the siloxane-containing polycarbonate resin (C-1) and 100 parts by weight of the polycarbonate resin (D-1).

### Comparative Example 2-5

In Example 2-2, the laminated electrophotographic photoreceptor was prepared in exactly the same manner except for changing the first resin in the charge transport layer coating solution to the siloxane-containing polycarbonate resin (C-6) having the viscosity average molecular weight of 50,000.

### Comparative Example 2-6

In Example 2-5, the laminated electrophotographic photoreceptor was prepared in exactly the same manner except for changing the first resin in the charge transport layer coating solution to the siloxane-containing polycarbonate resin (C-6) having the viscosity average molecular weight of 50,000.

### Comparative Example 2-7

In Example 2-4, the laminated electrophotographic photoreceptor was prepared in exactly the same manner except for changing the first resin in the charge transport layer coating solution to the siloxane-containing polycarbonate resin (C-7) having the viscosity average molecular weight of 7,000.

### <Evaluation of Photoreceptors in Examples and Comparative Examples>

The photoreceptors prepared in Examples 1-1 to 1-15 and Comparative Examples 1-1 to 1-7 were evaluated for the following (1) to (3). The results are shown in the tables.

For the photoreceptors according to the above-prepared Examples 2-1 to 2-19 and Comparative Examples 2-1 to 2-7, the following (1) to (4) were performed. The results are shown in Tables 3A-3C.

### [(1) Measurement of Surface Free Energy of Photosensitive Layer]

The surface free energy of the photosensitive layer (more specifically, the charge transport layer, which is the outermost surface layer) of each manufactured laminated photoreceptor was measured using the following method. A cotton swab soaked in methanol was used to wipe the surface of the photosensitive layer of the laminated photoreceptor. After the methanol was dried, a 3 mL droplet of water (pure water) was placed on the surface of the photosensitive layer. The first contact angle, which is the contact angle between the water and the photosensitive layer, was measured using the contact angle measuring device (“OCA20,” manufactured by Eiko Seiki Co., Ltd.). The contact angle measurement conditions were as follows.
Timing of contact angle measurement: 3 seconds after droplet placement
Measurement environment: Temperature 23 °C, relative humidity 50% RH

Except that water was replaced with PEG (Polyethylene Glycol 200, sold by Nacalai Tesque Inc.), the second contact angle, which is the contact angle between the photosensitive layer and a droplet of PEG 200, was measured using the same method as for the first contact angle.

Except that tricresyl phosphate (sold by Nacalai Tesque Inc.) was used instead of water, the third contact angle, which is the contact angle between the photosensitive layer and a droplet of the tricresyl phosphate, was measured using the same method as for the first contact angle.

The surface free energy of the photosensitive layer (unit: mJ/m²) was calculated using the method described in the embodiment, from the measured first to third contact angles, using the “SCA20” software installed on the contact angle measuring device. The calculated surface free energy of the photosensitive layer is shown in Tables 2A-2B and 3A-3C.

### [(2) Measurement of Surface Hardness]

The Martens hardness of the photosensitive layer was measured using a nanoindentation method compliant with ISO 14577, employing a hardness tester (“FISCHER SCOPE (registered trademark) HM2000XYp,” manufactured by Fischer Instruments K.K.). The measurement conditions were: temperature 23 °C and 50% RH. A diamond square-pyramid indenter (1350 dihedral angle) was contacted with the surface of the photoreceptor (the photosensitive layer). A load was gradually applied at a rate of 0.4 μm/20 seconds until a penetration depth of 0.4 μm was reached. The load was then held for 5 seconds, and unloaded after holding for 20 seconds.

### [(3) Measurement of Wear Amount]

A color printer (“C844dnw” manufactured by Oki Data Corporation) was used as an evaluation machine. The toner cartridge of the evaluation machine was filled with the cyan toner. First, the thickness T 1 of the charge transport layer of the laminated photoreceptor was measured. Next, the laminated photoreceptor was loaded into the evaluation machine. Next, under normal temperature and humidity conditions (temperature 23 °C and relative humidity 50% RH; hereinafter sometimes referred to as the NN environment), an image I (a pattern image with a 1% print density) was printed onto 4,000 sheets of paper using the evaluation machine. Subsequently, under high temperature and humidity conditions (temperature 32 °C and relative humidity 85% RH; hereinafter sometimes referred to as the HH environment), the image I was printed onto 4,000 sheets of paper using the evaluation machine. Next, under a low-temperature, low-humidity environment (temperature 10 °C and relative humidity 15% RH: hereinafter sometimes referred to as the LL environment), the image I was printed onto 4,000 sheets of paper using the evaluation machine. After printing under the LL environment, the evaluation machine was left to stand for 2 hours. Next, a solid image (image with 100% density) was printed onto one sheet of paper under the LL conditions, which was used as the evaluation image. Subsequently, the thickness T2 of the charge transport layer of the laminated photoreceptor was measured. The wear amount (T1-T2, unit: μm), which is the change in thickness of the charge transport layer before and after printing, was then calculated. Note that the smaller wear amount indicates the excellent wear resistance of the laminated photoreceptor.

### [(4) Repeatability Characteristics (Stability of Surface Potential During Repeated Use)]

A pseudo-evaluation of smear was performed using a electrical characteristic tester. Using the electrical characteristic tester manufactured by GENTEC Corporation, charging was performed at a rotational speed of 31 rpm and a charging potential of −600 V. Next, monochromatic light (wavelength: 780 nm, exposure dose: 0.8 μJ/cm²) was extracted from a halogen lamp using a bandpass filter and irradiated onto the surface of the photoreceptor. The surface potential of the photoreceptor was measured after 80 milliseconds when the exposure light was irradiated. The obtained surface potential was defined as an initial sensitivity potential (VLₒ). Next, monochromatic light (wavelength: 660 nm, exposure dose: 5.0 μJ/cm²) was irradiated onto the surface of the photoreceptor and electricity was removed. This charging-exposure-electricity removal cycle was repeated, rotating the photoreceptor 10,000 times. Subsequently, charging and exposure were performed under the same conditions, and the sensitivity potential was measured 80 milliseconds after the exposure light was applied. The obtained surface potential was designated as the sensitivity potential after 10,000 rotations (VL10,000). A smaller absolute value of a sensitivity potential difference between initial and after 10,000 rotations indicates superior stability.

ΔVL=|VL0−VL10,000|

### [Evaluation of Filming Resistance, Wear Resistance, and Smear Image]

Using the above measurement results, the anti-filming, the wear resistance, and the smear were evaluated.

### (Evaluation Criteria for Anti-filming Properties)

The lower surface free energy indicates excellent anti-filming properties. Specifically, the surface free energy of 25.0 mN/m or lower was considered good.

### (Evaluation Criteria for Wear Resistance)

The results for the Martens hardness and the wear amount were evaluated as follows.
Exceptionally good wear resistance: Martens hardness of 200 N/mm² or higher, and wear amount of 2.0 μm or less
Good wear resistance: Martens hardness of 197 N/mm² or higher and less than 200 N/mm², and wear amount of greater than 2.0 μm and 2.3 μm or less
Poor wear resistance: Martens hardness of less than 197 N/mm², and wear amount of greater than 2.3 μm.

### (Evaluation of Smear Image)

Very good: If the absolute value of the sensitivity potential difference between initial and after 10,000 rotations is less than 20V, the repeatability characteristics of the sensitivity is stable, enabling the formation of the image with little smear.
Good: If the absolute value of the sensitivity potential difference between initial and after 10,000 rotations is 30V or less, the repeatability characteristics of the sensitivity is relatively stable, enabling the formation of the image with less smear to a degree acceptable for practical use.
Poor: If the absolute value of the sensitivity potential difference between initial and after 10,000 rotations exceeds 30V, the repeatability characteristics of the sensitivity is unstable, resulting in the formation of the smear image.

TABLE 2A

| | First resin | | | Second | | |
|---|---|---|---|---|---|---|
| | | Molecular | | resin | | |
| | Type | weight | Parts | Type | Parts | HTM |
| Example 1-1 | A-1 | 20,000 | 5 | B-1 | 95 | H-1 |
| Example 1-2 | A-1 | 20,000 | 15 | B-1 | 85 | H-1 |
| Example 1-3 | A-1 | 20,000 | 25 | B-1 | 75 | H-1 |
| Example 1-4 | A-2 | 20,000 | 15 | B-1 | 85 | H-1 |
| Example 1-5 | A-3 | 20,000 | 15 | B-1 | 85 | H-1 |
| Example 1-6 | A-1 | 20,000 | 15 | B-2 | 85 | H-1 |
| Example 1-7 | A-1 | 20,000 | 15 | B-3 | 85 | H-1 |
| Example 1-8 | A-4 | 10,000 | 15 | B-1 | 85 | H-1 |
| Example 1-9 | A-5 | 25,000 | 15 | B-1 | 85 | H-1 |
| Example 1-10 | A-1 | 20,000 | 15 | B-1 | 85 | H-2 |
| Example 1-11 | A-1 | 20,000 | 15 | B-1 | 85 | H-3 |
| Example 1-12 | A-1 | 20,000 | 15 | B-1 | 85 | H-4 |
| Example 1-13 | A-1 | 20,000 | 15 | B-1 | 85 | H-5 |
| Example 1-14 | A-1 | 20,000 | 15 | B-1 | 85 | H-6 |
| Example 1-15 | A-1 | 20,000 | 15 | B-1 | 85 | H-7 |
| Comparative | A-1 | 20,000 | 100 | — | — | H-1 |
| example 1-1 | | | | | | |
| Comparative | — | — | — | B-1 | 100 | H-1 |
| example 1-2 | | | | | | |
| Comparative | A-1 | 20,000 | 40 | B-1 | 60 | H-1 |
| example 1-3 | | | | | | |
| Comparative | A-4 | 10,000 | 40 | B-1 | 60 | H-1 |
| example 1-4 | | | | | | |
| Comparative | A-5 | 25,000 | 40 | B-1 | 60 | H-1 |
| example 1-5 | | | | | | |
| Comparative | A-6 | 50,000 | 5 | B-1 | 95 | H-1 |
| example 1-6 | | | | | | |
| Comparative | A-6 | 50,000 | 25 | B-1 | 75 | H-1 |
| example 1-7 | | | | | | |

TABLE 2B

| | Surface | Martens | Wear |
|---|---|---|---|
| | free E | hardness | amount |
| | mN/m | N/mm2 | μm |
| Example 1-1 | 24.2 | 210 | 1.5 |
| Example 1-2 | 18.6 | 205 | 1.7 |
| Example 1-3 | 18.3 | 202 | 1.9 |
| Example 1-4 | 18.9 | 200 | 2.1 |
| Example 1-5 | 18.6 | 233 | 1.3 |
| Example 1-6 | 18.5 | 223 | 1.2 |
| Example 1-7 | 18.4 | 245 | 1.1 |
| Example 1-8 | 18.0 | 198 | 2.2 |
| Example 1-9 | 24.8 | 210 | 1.6 |
| Example 1-10 | 19.0 | 204 | 1.8 |
| Example 1-11 | 18.9 | 222 | 1.4 |
| Example 1-12 | 18.4 | 219 | 1.5 |
| Example 1-13 | 18.3 | 250 | 1.7 |
| Example 1-14 | 18.6 | 225 | 1.9 |
| Example 1-15 | 18.8 | 240 | 1.6 |
| Comparative | 16.9 | 179 | 3.5 |
| example 1-1 | | | |
| Comparative | 28.4 | 223 | 1.3 |
| example 1-2 | | | |
| Comparative | 17.9 | 196 | 2.4 |
| example 1-3 | | | |
| Comparative | 17.4 | 190 | 2.8 |
| example 1-4 | | | |
| Comparative | 25.6 | 202 | 1.9 |
| example 1-5 | | | |
| Comparative | 28.6 | 215 | 1.4 |
| example 1-6 | | | |
| Comparative | 25.5 | 205 | 1.8 |
| example 1-7 | | | |

TABLE 3A

| | First resin | | | | |
|---|---|---|---|---|---|
| | | Molecular | | Second resin | |
| | Type | weight | Parts | Type | Parts |
| Example 2-1 | C-1 | 20,000 | 5 | D-1 | 95 |
| Example 2-2 | C-1 | 20,000 | 5 | D-1 | 95 |
| Example 2-3 | C-1 | 20,000 | 5 | D-1 | 95 |
| Example 2-4 | C-1 | 20,000 | 15 | D-1 | 85 |
| Example 2-5 | C-1 | 20,000 | 25 | D-1 | 75 |
| Example 2-6 | C-2 | 10,000 | 15 | D-1 | 85 |
| Example 2-7 | C-3 | 25,000 | 15 | D-1 | 85 |
| Example 2-8 | C-1 | 20,000 | 15 | D-2 | 85 |
| Example 2-9 | C-1 | 20,000 | 15 | D-3 | 85 |
| Example 2-10 | C-1 | 20,000 | 15 | D-1 | 85 |
| Example 2-11 | C-1 | 20,000 | 15 | D-1 | 85 |
| Example 2-12 | C-1 | 20,000 | 15 | D-1 | 85 |
| Example 2-13 | C-1 | 20,000 | 15 | D-1 | 85 |
| Example 2-14 | C-1 | 20,000 | 15 | D-1 | 85 |
| Example 2-15 | C-1 | 20,000 | 15 | D-1 | 85 |
| Example 2-16 | C-1 | 20,000 | 5 | D-1 | 95 |
| Example 2-17 | C-1 | 20,000 | 5 | D-1 | 95 |
| Example 2-18 | C-1 | 20,000 | 5 | D-1 | 95 |
| Example 2-19 | C-1 | 20,000 | 5 | D-1 | 95 |
| Comparative | C-1 | 20,000 | 40 | D-1 | 60 |
| example 2-1 | | | | | |
| Comparative | C-1 | 20,000 | 30 | D-1 | 70 |
| example 2-2 | | | | | |
| Comparative | C-2 | 10,000 | 30 | D-1 | 70 |
| example 2-3 | | | | | |
| Comparative | — | — | — | D-1 | 100 |
| example 2-4 | | | | | |
| Comparative | C-4 | 50,000 | 5 | D-1 | 95 |
| example 2-5 | | | | | |
| Comparative | C-4 | 50,000 | 25 | D-1 | 75 |
| example 2-6 | | | | | |
| Comparative | C-5 | 7,000 | 15 | D-1 | 85 |
| example 2-7 | | | | | |

TABLE 3B

| | Hole | | | Surface |
|---|---|---|---|---|
| | transport | Pigment | | free E |
| | agent | Type | Parts | mN/m |
| Example 2-1 | H-1 | K-1 | 0.1 | 24.2 |
| Example 2-2 | H-1 | K-1 | 0.3 | 24.2 |
| Example 2-3 | H-1 | K-1 | 0.7 | 24.4 |
| Example 2-4 | H-1 | K-1 | 0.3 | 18.6 |
| Example 2-5 | H-1 | K-1 | 0.3 | 18.3 |
| Example 2-6 | H-1 | K-1 | 0.3 | 18.0 |
| Example 2-7 | H-1 | K-1 | 0.3 | 24.8 |
| Example 2-8 | H-1 | K-1 | 0.3 | 18.7 |
| Example 2-9 | H-1 | K-1 | 0.3 | 18.2 |
| Example 2-10 | H-2 | K-1 | 0.3 | 19.0 |
| Example 2-11 | H-3 | K-1 | 0.3 | 18.9 |
| Example 2-12 | H-4 | K-1 | 0.3 | 18.4 |
| Example 2-13 | H-5 | K-1 | 0.3 | 18.3 |
| Example 2-14 | H-6 | K-1 | 0.3 | 18.6 |
| Example 2-15 | H-7 | K-1 | 0.3 | 18.8 |
| Example 2-16 | H-1 | K-2 | 0.3 | 24.2 |
| Example 2-17 | H-1 | — | — | 24.3 |
| Example 2-18 | H-1 | K-3 | 0.3 | 24.4 |
| Example 2-19 | H-1 | K-4 | 0.3 | 24.1 |
| Comparative | H-1 | — | — | 16.5 |
| example 2 -1 | | | | |
| Comparative | H-1 | K-1 | 0.3 | 17.9 |
| example 2-2 | | | | |
| Comparative | H-1 | K-1 | 0.3 | 17.4 |
| example 2-3 | | | | |
| Comparative | H-1 | K-1 | 0.3 | 29.8 |
| example 2-4 | | | | |
| Comparative | H-1 | K-1 | 0.3 | 28.6 |
| example 2-5 | | | | |
| Comparative | H-1 | K-1 | 0.3 | 25.5 |
| example 2-6 | | | | |
| Comparative | H-1 | K-1 | 0.3 | 18.5 |
| example 2-7 | | | | |

TABLE 3C

| | Martens | Wear | |
|---|---|---|---|
| | hardness | amount | ΔVL |
| | N/mm2 | μm | VL0-VL10,000 |
| Example 2-1 | 210 | 1.5 | 15 V |
| Example 2-2 | 210 | 1.6 | 7 V |
| Example 2-3 | 210 | 1.6 | 2 V |
| Example 2-4 | 205 | 1.7 | 3 V |
| Example 2-5 | 202 | 1.9 | 5 V |
| Example 2-6 | 198 | 2.2 | 6 V |
| Example 2-7 | 210 | 1.6 | 4 V |
| Example 2-8 | 221 | 1.2 | 5 V |
| Example 2-9 | 239 | 1.1 | 10 V |
| Example 2-10 | 204 | 1.8 | 3 V |
| Example 2-11 | 222 | 1.4 | 6 V |
| Example 2-12 | 219 | 1.5 | 4 V |
| Example 2-13 | 250 | 1.7 | 15 V |
| Example 2-14 | 225 | 1.9 | 10 V |
| Example 2-15 | 240 | 1.6 | 19 V |
| Example 2-16 | 210 | 1.6 | 10 V |
| Example 2-17 | 210 | 1.6 | 25 V |
| Example 2-18 | 211 | 1.5 | 28 V |
| Example 2-19 | 210 | 1.7 | 26 V |
| Comparative | 185 | 2.8 | 20 V |
| example 2-1 | | | |
| Comparative | 196 | 2.4 | 15 V |
| example 2-2 | | | |
| Comparative | 190 | 2.8 | 15 V |
| example 2-3 | | | |
| Comparative | 220 | 1.4 | 18 V |
| example 2-4 | | | |
| Comparative | 215 | 1.4 | 15 V |
| example 2-5 | | | |
| Comparative | 205 | 1.8 | 15 V |
| example 2-6 | | | |
| Comparative | 189 | 3.0 | 12 V |
| example 2-7 | | | |

As shown in Tables 2A-2B, the photoreceptor according to Comparative Example 1-1 had the content ratio of the resin (A-1) of 35% or more and did not contain the second resin. Consequently, the wear resistance was poor.

The photoreceptor according to Comparative Example 1-2 did not contain the first resin having the siloxane structure. Consequently, it exhibited poor anti-filming properties.

The photoreceptors according to Comparative Examples 1-3 to 1-5 each had the content ratio of the resins (A-1), (A-4), and (A-5) of 35% or more. Consequently, either the anti-filming properties or the wear resistance was poor.

The photoreceptors according to Comparative Examples 1-6 to 1-7 each used the resin (A-6) having the viscosity average molecular weight exceeding 25,000. Consequently, Comparative Examples 1-6 to 1-7 exhibited poor anti-filming properties.

As shown in Tables 3A-3C, the photoreceptors according to Comparative Examples 2-1 to 2-2 each had the content ratio of the resin (C-1) being 35% or more, and the content ratio of the resin (C-2) being 35% or more. These resins were not included in the first resin of the present disclosure. Therefore, the photoreceptors according to Comparative Examples 2-1 to 2-3 exhibited poor wear resistance.

The photoreceptor according to Comparative Example 2-4 did not contain the resin included in the first resin of the present disclosure. Consequently, it exhibited poor anti-filming properties.

The photoreceptors according to Comparative Examples 2-5 to 2-7 each used the resins (C-4) and (C-5) having the viscosity average molecular weight outside the range of 10,000 to 25,000. Consequently, Comparative Examples 2-5 to 2-7 exhibited inferior results in either the anti-filming properties or the wear resistance.

The photoreceptors according to Comparative Examples 2-5 to 2-6 each used the resin (C-4) having the viscosity average molecular weight exceeding 25,000. Consequently, Comparative Examples 2-5 to 2-6 exhibited poor anti-filming properties. The photoreceptors according to Comparative Example 2-7 each used the resin (C-5) having the viscosity average molecular weight below 10,000. Consequently, Comparative Example 2-7 exhibited reduced Martens hardness and increased wear amount, failing to achieve the excellent wear resistance.

As evident from Tables 2A-2B and 3A-3C, the photoreceptors according to Examples 1-1 to 1-15 and the photoreceptors according to Examples 2-1 to 2-19 were found to exhibit excellent wear resistance and anti-filming properties and form the images with less smear to a degree acceptable for practical use compared to the photoreceptors according to Comparative Examples 1-1 to 1-7 and photoreceptors according to Comparative Examples 2-1 to 2-7. In particular, it was found that the photoreceptors according to Examples 2-1 to 2-16 can form the images with almost no smear compared to the photoreceptors according to Examples 2-17 to 2-19.

Those skilled in the art will understand that various modifications, combinations, subcombinations, and alterations may be made within the scope of the appended claims or their equivalents, depending on design requirements and other factors.

What is claimed is:

1. An electrophotographic photoreceptor, comprising:
a conductive base; and
a photosensitive layer,
wherein the photosensitive layer includes a charge generation layer and a charge transport layer,
wherein the charge transport layer includes a hole transport agent and a binder resin containing a first resin and a second resin,
wherein the first resin is a polycarbonate resin containing repeating units having a siloxane structure, and a viscosity average molecular weight of the first resin is within the range of 10,000 or more and 25,000 or less,
wherein the second resin is at least one type of a resin selected from the group consisting of polycarbonate resins and a polyarylate resin, which does not contain the repeating units having the siloxane structure, and
wherein a content ratio of the first resin relative to the binder resin is 5 mass % or more and less than 35 mass %.

2. The electrophotographic photoreceptor according to claim 1, wherein the charge transport layer further contains a phthalocyanine pigment.

3. The electrophotographic photoreceptor according to claim 1, wherein, when the total amount of the first resin is 100 mol %, a content ratio of the repeating units having the siloxane structures is 0.5 mol % or more and 20 mol % or less.

4. The electrophotographic photoreceptor according to claim 2, wherein the phthalocyanine pigment is a metal-free phthalocyanine or a compound represented by the following formula (1) 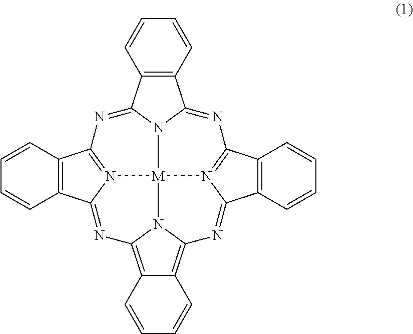
in the above formula (1), M represents a metal atom which may have a ligand.

5. The electrophotographic photoreceptor according to claim 1, wherein surface free energy of the photosensitive layer is 25.0 mN/m or less.

6. The electrophotographic photoreceptor according to claim 1, wherein the Martens hardness of the photosensitive layer is 200 N/mm² or more.

7. A process cartridge, comprising the electrophotographic photoreceptor according to claim 1.

8. An image forming apparatus, comprising:
an image carrier;
a charging device for charging a surface of the image carrier;
an exposure device for exposing the surface of the charged image carrier to form an electrostatic latent image on the surface of the image carrier;
a developing device for supplying toner to the surface of the image carrier to develop the electrostatic latent image into a toner image; and
a transfer device for transferring the toner image from the image carrier to a transfer target,
wherein the image carrier is the electrophotographic photoreceptor according to claim 1.
